(19) United States
(12) Patent Application Publication
(10) Pub. No.: US 2022/0158798 A1
(43) Pub. Date: May 19, 2022

(54) METHOD FOR REPORTING CHANNEL STATE INFORMATION IN WIRELESS COMMUNICATION SYSTEM, AND APPARATUS THEREFOR

(71) Applicant: LG ELECTRONICS INC., Seoul (KR)

(72) Inventors: Jaehoon CHUNG, Seoul (KR); Haewook PARK, Seoul (KR); Jiwon KANG, Seoul (KR)

(21) Appl. No.: 17/438,664

(22) PCT Filed: Feb. 11, 2020
(86) PCT No.: PCT/KR2020/001896

§ 371 Date: Sep. 13, 2021

Related U.S. Application Data
(60) Provisional application No. 62/818,089, filed on Mar. 13, 2019.
(60) Provisional application No. 62/818,090, filed on Mar. 13, 2019.
(60) Provisional application No. 62/818,093, filed on Mar. 13, 2019.

(51) Int. Cl. H04L 5/00

(52) U.S. Cl. CPC H04L 5/0053

(57) ABSTRACT

The present disclosure provides a method for reporting channel state information in a wireless communication system, and an apparatus therefor. Specifically, a method for reporting channel state information (CSI) by a terminal (user equipment, UE) in a wireless communication system comprises the steps of: receiving CSI-related configuration information from a base station (BS); receiving a reference signal from the base station; calculating CSI on the basis of the reference signal; and transmitting, to the base station, uplink control information (UCI) for reporting of the CSI, wherein the CSI is calculated based on a codebook, and the CSI includes first information and second information selected based on the first information.

### TECHNICAL FIELD

The disclosure relates to a wireless communication system, and more specifically, to a method for reporting channel state information based on a codebook design elaborate and efficient in light of overhead and a device for supporting the same.

### BACKGROUND ART

Mobile communication systems have been developed to provide a voice service while ensuring the activity of a user. However, in the mobile communication system, not only a voice, but also a data service is extended. At present, there is a shortage of resources due to an explosive increase in traffic, and users demand a higher speed service. As a result, a more advanced mobile communication system is required.

Requirements for a next-generation mobile communication system should be able to support the acceptance of explosive data traffic, a dramatic increase in the per-user data rate, the acceptance of a significant increase in the number of connected devices, very low end-to-end latency, and high-energy efficiency. To this end, various technologies are researched, which include dual connectivity, massive multiple input multiple output (MIMO), in-band full duplex, non-orthogonal multiple access (NOMA), super wideband support, device networking, and the like.

### DISCLOSURE

### Technical Problem

The disclosure proposes a method for reporting channel state information (CSI) in a wireless communication system.

Specifically, the disclosure proposes a method for designing a codebook that is elaborate and efficient in terms of overhead, and reporting channel state information based thereupon.

Further, the present disclosure proposes a method for differentially configuring a codebook construction parameter by considering characteristics for each rank indicator (RI)/layer.

Further, the present disclosure proposes a method for calculating and reporting CSI based on a codebook configured by considering characteristics for each rank indicator (RI)/layer.

Further, the present disclosure proposes a method for selecting some from all elements constituting a spatial domain basis, a frequency domain basis, etc., and constructing UCI for reporting the CSI with an element selected from some selected elements.

Technical objects to be achieved in the disclosure are not limited to the aforementioned technical objects, and other technical objects not described above may be evidently understood by a person having ordinary skill in the art to which the disclosure pertains from the following description.

### Technical Solution

According to an embodiment of the present disclosure, a method of reporting, by a user equipment (UE), channel state information (CSI) in wireless communication system may include: receiving, from a base station (BS), CSI related configuration information; receiving, from the BS, a reference signal; calculating CSI based on the reference signal; and transmitting, to the BS, Uplink Control Information (UCI) for reporting the CSI, here, the CSI may be calculated based on a codebook, and the CSI may include first information and second information selected based on the first information.

Further, according to an embodiment of the present disclosure, in the method, the first information is information related with a basis of frequency domain.

Further, according to an embodiment of the present disclosure, in the method, the second information may be selected using combinations.

Further, according to an embodiment of the present disclosure, in the method, the UCI may include a first part and a second part, and the first information and the second information may be included in the second part.

Further, according to an embodiment of the present disclosure, in the method, only a part of the second information may be included in the UCI.

Further, according to an embodiment of the present disclosure, in the method, a bit width of the UCI may be determined based on the first information and the second information.

Further, according to an embodiment of the present disclosure, in the method, the codebook may be determined based on information related to a codebook configuration parameter.

Further, according to an embodiment of the present disclosure, in the method, the information related to the codebook configuration parameter may include at least one of first parameter information related to a number of bases of spatial domain, second parameter information related to a number of bases of frequency domain, or third parameter information related to a linear combination coefficient.

Further, according to an embodiment of the present disclosure, in the method, the first parameter information may be commonly configured to a rank indicator (RI).

Further, according to an embodiment of the present disclosure, in the method, the second parameter information may be configured based on one of a rank indicator (RI) or a layer.

Furthermore, in the method according to an embodiment of the present disclosure, the CSI related configuration information may include information related to the codebook.

Further, according to an embodiment of the present disclosure, in the method, the codebook may be configured based on at least one of a rank indicator (RI) or a layer.

According to an embodiment of the present disclosure, a user equipment (UE) for reporting channel state information (CSI) in wireless communication system may include: one or more transceivers; one or more processors; and one or more memories storing instructions for operations executed by the one or more processors and connected to the one or more processors, here, the operations may include: receiving, from a base station (BS), CSI related configuration information; receiving, from the BS, a reference signal; calculating CSI based on the reference signal; and transmitting, to the BS, Uplink Control Information (UCI) for reporting the CSI, the CSI may be calculated based on a codebook, and the CSI may include first information and second information selected based on the first information.

Further, according to an embodiment of the present disclosure, in the method, the first information may be information related with a basis of frequency domain.

According to an embodiment of the present disclosure, a method of receiving, by a base station (BS), channel state information (CSI) in wireless communication system may include: transmitting, to a user equipment (UE), CSI related configuration information; transmitting, to the UE, a reference signal; and receiving, from the UE, Uplink Control Information (UCI) for reporting the CSI, here, the CSI may be calculated based on a codebook, and the CSI may include first information and second information selected based on the first information.

According to an embodiment of the present disclosure, a base station (BS) for receiving channel state information (CSI) in wireless communication system may include: one or more transceivers; one or more processors; and one or more memories storing instructions for operations executed by the one or more processors and connected to the one or more processors, here, the operations may include: transmitting, to a user equipment (UE), CSI related configuration information; transmitting, to the UE, a reference signal; and receiving, from the UE, Uplink Control Information (UCI) for reporting the CSI, the CSI may be calculated based on a codebook, and the CSI may include first information and second information selected based on the first information.

According to an embodiment of the present disclosure, an apparatus may include: one or more memories and one or more processors functionally connected to the one or more memories, here, the one or more processors may control the apparatus to: receive, from a base station (BS), CSI related configuration information; receive, from the BS, a reference signal; calculate CSI based on the reference signal; and transmit, to the BS, Uplink Control Information (UCI) for reporting the CSI, the CSI may be calculated based on a codebook, and the CSI may include first information and second information selected based on the first information.

According to an embodiment of the present disclosure, in one or more non-transitory computer-readable media storing one or more instructions, the one or more instructions executable by one or more processors may include instructions for instructing a user equipment (UE) to: receive, from a base station (BS), CSI related configuration information; receive, from the BS, a reference signal; calculate CSI based on the reference signal; and transmit, to the BS, Uplink Control Information (UCI) for reporting the CSI, the CSI may be calculated based on a codebook, and the CSI may include first information and second information selected based on the first information.

### Advantageous Effects

According to an embodiment of the present disclosure, a codebook may be constructed by considering characteristics for each rank indicator (RI)/layer.

Further, according to an embodiment of the present disclosure, channel state reporting can be performed which is sophisticated, and efficient in terms of overhead based on the codebook.

Further, according to an embodiment of the present disclosure, UCI may be constructed by selecting a component stepwise (e.g., 2 steps) for CSI reporting.

Effects which may be obtained from the disclosure are not limited by the above effects, and other effects that have not been mentioned may be clearly understood from the following description by those skilled in the art to which the disclosure pertains.

### DESCRIPTION OF DRAWINGS

The accompany drawings, which are included to provide a further understanding of the disclosure and are incorporated on and constitute a part of this disclosure illustrate embodiments of the disclosure and together with the description serve to explain the principles of the disclosure.

FIG. 1 is a diagram illustrating an example of an overall system structure of NR to which a method proposed in the disclosure may be applied.

FIG. 2 illustrates a relationship between an uplink frame and a downlink frame in a wireless communication system to which a method proposed in the disclosure may be applied.

FIG. 3 illustrates an example of a frame structure in an NR system.

FIG. 4 illustrates an example of a resource grid supported by a wireless communication system to which a method proposed in the disclosure may be applied.

FIG. 5 illustrates examples of a resource grid for each antenna port and numerology to which a method proposed in the disclosure may be applied.

FIG. 6 illustrates physical channels and general signal transmission used in a 3GPP system.

FIG. 7 is a flowchart illustrating an example CSI-related procedure.

FIG. 8 illustrates an example of an operation flow of a UE performing CSI reporting to which a method and/or an embodiment proposed in the present disclosure may be applied.

FIG. 9 illustrates an example of an operation flowchart of a BS and a UE to which a method and/or an embodiment proposed in the present disclosure may be applied.

FIG. 10 illustrates a communication system (1) applied to the disclosure.

FIG. 11 illustrates a wireless device which may be applied to the disclosure.

FIG. 12 illustrates a signal processing circuit for a transmit signal.

FIG. 13 illustrates another example of a wireless device applied to the disclosure.

FIG. 14 illustrates a portable device applied to the disclosure.

### MODE FOR DISCLOSURE

Reference will now be made in detail to embodiments of the disclosure, examples of which are illustrated in the accompanying drawings. A detailed description to be disclosed below together with the accompanying drawing is to describe exemplary embodiments of the disclosure and not to describe a unique embodiment for carrying out the disclosure. The detailed description below includes details to provide a complete understanding of the disclosure. However, those skilled in the art know that the disclosure may be carried out without the details.

In some cases, in order to prevent a concept of the disclosure from being ambiguous, known structures and devices may be omitted or illustrated in a block diagram format based on core functions of each structure and device.

Hereinafter, downlink (DL) means communication from the base station to the terminal and uplink (UL) means communication from the terminal to the base station. In downlink, a transmitter may be part of the base station, and a receiver may be part of the terminal. In uplink, the transmitter may be part of the terminal and the receiver may be part of the base station. The base station may be expressed as a first communication device and the terminal may be expressed as a second communication device. A base station (BS) may be replaced with terms including a fixed station, a Node B, an evolved-NodeB (eNB), a Next Generation NodeB (gNB), a base transceiver system (BTS), an access point (AP), a network (5G network), an AI system, a road side unit (RSU), a vehicle, a robot, an Unmanned Aerial Vehicle (UAV), an Augmented Reality (AR) device, a Virtual Reality (VR) device, and the like. Further, the terminal may be fixed or mobile and may be replaced with terms including a User Equipment (UE), a Mobile Station (MS), a user terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, and a Device-to-Device (D2D) device, the vehicle, the robot, an AI module, the Unmanned Aerial Vehicle (UAV), the Augmented Reality (AR) device, the Virtual Reality (VR) device, and the like.

The following technology may be used in various radio access system including CDMA, FDMA, TDMA, OFDMA, SC-FDMA, and the like. The CDMA may be implemented as radio technology such as Universal Terrestrial Radio Access (UTRA) or CDMA2000. The TDMA may be implemented as radio technology such as a global system for mobile communications (GSM)/general packet radio service (GPRS)/enhanced data rates for GSM evolution (EDGE). The OFDMA may be implemented as radio technology such as Institute of Electrical and Electronics Engineers (IEEE) 802.11 (Wi-Fi), IEEE 802.16 (WiMAX), IEEE 802.20, Evolved UTRA (E-UTRA), or the like. The UTRA is a part of Universal Mobile Telecommunications System (UMTS). 3rd Generation Partnership Project (3GPP) Long Term Evolution (LTE) is a part of Evolved UMTS (E-UMTS) using the E-UTRA and LTE-Advanced (A)/LTE-A pro is an evolved version of the 3GPP LTE. 3GPP NR (New Radio or New Radio Access Technology) is an evolved version of the 3GPP LTE/LTE-A/LTE-A pro.

For clarity of description, the technical spirit of the disclosure is described based on the 3GPP communication system (e.g., LTE-A or NR), but the technical spirit of the disclosure are not limited thereto. LTE means technology after 3GPP TS 36.xxx Release 8. In detail, LTE technology after 3GPP TS 36.xxx Release 10 is referred to as the LTE-A and LTE technology after 3GPP TS 36.xxx Release 13 is referred to as the LTE-A pro. The 3GPP NR means technology after TS 38.xxx Release 15. The LTE/NR may be referred to as a 3GPP system. “xxx” means a detailed standard document number. The LTE/NR may be collectively referred to as the 3GPP system. Matters disclosed in a standard document opened before the disclosure may be referred to for a background art, terms, omissions, etc., used for describing the disclosure. For example, the following documents may be referred to.

3GPP LTE
36.211: Physical channels and modulation
36.212: Multiplexing and channel coding
36.213: Physical layer procedures
36.300: Overall description
36.331: Radio Resource Control (RRC)

3GPP NR
38.211: Physical channels and modulation
38.212: Multiplexing and channel coding
38.213: Physical layer procedures for control
38.214: Physical layer procedures for data
38.300: NR and NG-RAN Overall Description
36.331: Radio Resource Control (RRC) protocol specification

As more and more communication devices require larger communication capacity, there is a need for improved mobile broadband communication compared to the existing radio access technology (RAT). Further, massive machine type communications (MTCs), which provide various services anytime and anywhere by connecting many devices and objects, are one of the major issues to be considered in the next generation communication. In addition, a communication system design considering a service/UE sensitive to reliability and latency is being discussed. The introduction of next generation radio access technology considering enhanced mobile broadband communication (eMBB), massive MTC (mMTC), ultra-reliable and low latency communication (URLLC) is discussed, and in the disclosure, the technology is called new RAT for convenience. The NR is an expression representing an example of 5G radio access technology (RAT).

Three major requirement areas of 5G include (1) an enhanced mobile broadband (eMBB) area, (2) a massive machine type communication (mMTC) area and (3) an ultra-reliable and low latency communications (URLLC) area.

Some use cases may require multiple areas for optimization, and other use case may be focused on only one key performance indicator (KPI). 5G support such various use cases in a flexible and reliable manner.

eMBB is far above basic mobile Internet access and covers media and entertainment applications in abundant bidirectional tasks, cloud or augmented reality. Data is one of key motive powers of 5G, and dedicated voice services may not be first seen in the 5G era. In 5G, it is expected that voice will be processed as an application program using a data connection simply provided by a communication system. Major causes for an increased traffic volume include an increase in the content size and an increase in the number of applications that require a high data transfer rate. Streaming service (audio and video), dialogue type video and mobile Internet connections will be used more widely as more devices are connected to the Internet. Such many application programs require connectivity always turned on in order to push real-time information and notification to a user. A cloud storage and application suddenly increases in the mobile communication platform, and this may be applied to both business and entertainment. Furthermore, cloud storage is a special use case that tows the growth of an uplink data transfer rate. 5G is also used for remote business of cloud. When a tactile interface is used, further lower end-to-end latency is required to maintain excellent user experiences. Entertainment, for example, cloud game and video streaming are other key elements which increase a need for the mobile broadband ability. Entertainment is essential in the smartphone and tablet anywhere including high mobility environments, such as a train, a vehicle and an airplane. Another use case is augmented reality and information search for entertainment. In this case, augmented reality requires very low latency and an instant amount of data.

Furthermore, one of the most expected 5G use case relates to a function capable of smoothly connecting embedded sensors in all fields, that is, mMTC. Until 2020, it is expected that potential IoT devices will reach 20.4 billions. The industry IoT is one of areas in which 5G performs major roles enabling smart city, asset tracking, smart utility, agriculture and security infra.

URLLC includes a new service which will change the industry through remote control of major infra and a link having ultra-reliability/low available latency, such as a self-driving vehicle. A level of reliability and latency is essential for smart grid control, industry automation, robot engineering, drone control and adjustment.

Multiple use cases are described more specifically.

5G may supplement fiber-to-the-home (FTTH) and cable-based broadband (or DOCSIS) as means for providing a stream evaluated from gigabits per second to several hundreds of mega bits per second. Such fast speed is necessary to deliver TV with resolution of 4K or more (6K, 8K or more) in addition to virtual reality and augmented reality. Virtual reality (VR) and augmented reality (AR) applications include immersive sports games. A specific application program may require a special network configuration. For example, in the case of VR game, in order for game companies to minimize latency, a core server may need to be integrated with the edge network server of a network operator.

An automotive is expected to be an important and new motive power in 5G, along with many use cases for the mobile communication of an automotive. For example, entertainment for a passenger requires a high capacity and a high mobility mobile broadband at the same time. The reason for this is that future users continue to expect a high-quality connection regardless of their location and speed. Another use example of the automotive field is an augmented reality dashboard. The augmented reality dashboard overlaps and displays information, identifying an object in the dark and notifying a driver of the distance and movement of the object, over a thing seen by the driver through a front window. In the future, a wireless module enables communication between automotives, information exchange between an automotive and a supported infrastructure, and information exchange between an automotive and other connected devices (e.g., devices accompanied by a pedestrian). A safety system guides alternative courses of a behavior so that a driver may drive more safely, thereby reducing a danger of an accident. A next step will be a remotely controlled or self-driven vehicle. This requires very reliable, very fast communication between different self-driven vehicles and between an automotive and infra. In the future, a self-driven vehicle may perform all driving activities, and a driver will be focused on things other than traffic, which cannot be identified by an automotive itself. Technical requirements of a self-driven vehicle require ultra-low latency and ultra-high speed reliability so that traffic safety is increased up to a level which cannot be achieved by a person.

A smart city and smart home mentioned as a smart society will be embedded as a high-density radio sensor network. The distributed network of intelligent sensors will identify the cost of a city or home and a condition for energy-efficient maintenance. A similar configuration may be performed for each home. All of a temperature sensor, a window and heating controller, a burglar alarm and home appliances are wirelessly connected. Many of such sensors are typically a low data transfer rate, low energy and a low cost. However, for example, real-time HD video may be required for a specific type of device for surveillance.

The consumption and distribution of energy including heat or gas are highly distributed and thus require automated control of a distributed sensor network. A smart grid collects information, and interconnects such sensors using digital information and a communication technology so that the sensors operate based on the information. The information may include the behaviors of a supplier and consumer, and thus the smart grid may improve the distribution of fuel, such as electricity, in an efficient, reliable, economical, production-sustainable and automated manner. The smart grid may be considered to be another sensor network having small latency.

A health part owns many application programs which reap the benefits of mobile communication. A communication system may support remote treatment providing clinical treatment at a distant place. This helps to reduce a barrier for the distance and may improve access to medical services which are not continuously used at remote farming areas. Furthermore, this is used to save life in important treatment and an emergency condition. A radio sensor network based on mobile communication may provide remote monitoring and sensors for parameters, such as the heart rate and blood pressure.

Radio and mobile communication becomes increasingly important in the industry application field. Wiring requires a high installation and maintenance cost. Accordingly, the possibility that a cable will be replaced with reconfigurable radio links is an attractive opportunity in many industrial fields. However, to achieve the possibility requires that a radio connection operates with latency, reliability and capacity similar to those of the cable and that management is simplified. Low latency and a low error probability is a new requirement for a connection to 5G.

Logistics and freight tracking is an important use case for mobile communication, which enables the tracking inventory and packages anywhere using a location-based information system. The logistics and freight tracking use case typically requires a low data speed, but a wide area and reliable location information.

In a new RAT system including NR uses an OFDM transmission scheme or a similar transmission scheme thereto. The new RAT system may follow OFDM parameters different from OFDM parameters of LTE. Alternatively, the new RAT system may follow numerology of conventional LTE/LTE-A as it is or have a larger system bandwidth (e.g., 100 MHz). Alternatively, one cell may support a plurality of numerologies. In other words, UEs that operate with different numerologies may coexist in one cell.

The numerology corresponds to one subcarrier spacing in a frequency domain. Different numerologies may be defined by scaling reference subcarrier spacing to an integer N.

### DEFINITION OF TERMS

eLTE eNB: The eLTE eNB is the evolution of eNB that supports connectivity to EPC and NGC.

gNB: A node which supports the NR as well as connectivity to NGC.

New RAN: A radio access network which supports either NR or E-UTRA or interfaces with the NGC.

Network slice: A network slice is a network created by the operator customized to provide an optimized solution for a specific market scenario which demands specific requirements with end-to-end scope.

Network function: A network function is a logical node within a network infrastructure that has well-defined external interfaces and well-defined functional behavior.

NG-C: A control plane interface used on NG2 reference points between new RAN and NGC.

NG-U: A user plane interface used on NG3 references points between new RAN and NGC.

Non-standalone NR: A deployment configuration where the gNB requires an LTE eNB as an anchor for control plane connectivity to EPC, or requires an eLTE eNB as an anchor for control plane connectivity to NGC.

Non-standalone E-UTRA: A deployment configuration where the eLTE eNB requires a gNB as an anchor for control plane connectivity to NGC.

User plane gateway: A termination point of NG-U interface.

Overview of System

FIG. 1 illustrates an example of an overall structure of a NR system to which a method proposed in the disclosure is applicable.

Referring to FIG. 1, an NG-RAN consists of gNBs that provide an NG-RA user plane (new AS sublayer/PDCP/RLC/MAC/PHY) and control plane (RRC) protocol terminations for a user equipment (UE).

The gNBs are interconnected with each other by means of an Xn interface.

The gNBs are also connected to an NGC by means of an NG interface.

More specifically, the gNBs are connected to an access and mobility management function (AMF) by means of an N2 interface and to a user plane function (UPF) by means of an N3 interface.

NR (New Rat) Numerology and Frame Structure

In the NR system, multiple numerologies may be supported. The numerologies may be defined by subcarrier spacing and a CP (Cyclic Prefix) overhead. Spacing between the plurality of subcarriers may be derived by scaling basic subcarrier spacing into an integer N (or μ). In addition, although a very low subcarrier spacing is assumed not to be used at a very high subcarrier frequency, a numerology to be used may be selected independent of a frequency band.

In addition, in the NR system, a variety of frame structures according to the multiple numerologies may be supported.

Hereinafter, an orthogonal frequency division multiplexing (OFDM) numerology and a frame structure, which may be considered in the NR system, will be described.

A plurality of OFDM numerologies supported in the NR system may be defined as in Table 1.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

The NR supports multiple numerologies (or subcarrier spacing (SCS)) for supporting various 5G services. For example, when the SCS is 15 kHz, a wide area in traditional cellular bands is supported and when the SCS is 30 kHz/60 kHz, dense-urban, lower latency, and wider carrier bandwidth are supported, and when the SCS is more than 60 kHz, a bandwidth larger than 24.25 GHz is supported in order to overcome phase noise.

An NR frequency band is defined as frequency ranges of two types (FR1 and FR2). FR1 and FR2 may be configured as shown in Table 2 below. Further, FR2 may mean a millimeter wave (mmW).

TABLE 2

| Frequency Range | Corresponding frequency | |
|---|---|---|
| designation | range | Subcarrier Spacing |
| FR1 | 410 MHz-7125 MHz | 15, 30, 60 kHz |
| FR2 | 24250 MHz-52600 MHz | 60, 120, 240 kHz |

Regarding a frame structure in the NR system, a size of various fields in the time domain is expressed as a multiple of a time unit of Tₛ=1/(Δfₘₐₓ·N_{f}). In this case, Δfₘₐₓ=480·10³, and N_{f}=4096. DL and UL transmission is configured as a radio frame having a section of T_{f}=(ΔfₘₐₓN_{f}/100)·Tₛ=10 ms. The radio frame is composed of ten subframes each having a section of T_{sf}=(ΔfₘₐₓN_{f}/1000)·Tₛ=1 ms. In this case, there may be a set of UL frames and a set of DL frames.

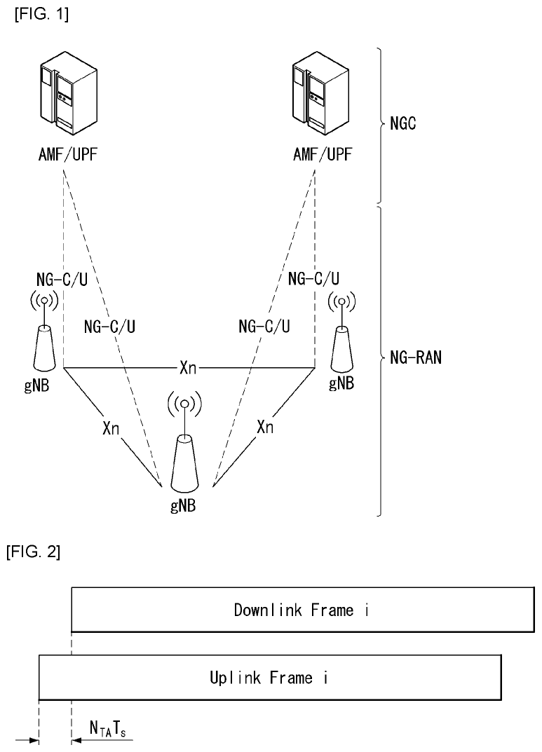

FIG. 2 illustrates a relation between an uplink frame and a downlink frame in a wireless communication system to which a method proposed in the disclosure is applicable.

As illustrated in FIG. 2, uplink frame number i for transmission from a user equipment (UE) shall start T_{TA}=N_{TA}Tₛ before the start of a corresponding downlink frame at the corresponding UE.

Regarding the numerology μ, slots are numbered in increasing order of nₛ^{μ}ε{0, . . . , N_{subframe}^{slots,μ}−1} within a subframe and are numbered in increasing order of n_{s,f}^{μ}ε{0, . . . , N_{frame}^{slots,μ}−1} within a radio frame. One slot consists of consecutive OFDM symbols of N_{symb}^{μ}, and N_{symb}^{μ} is determined depending on a numerology used and slot configuration. The start of slots nₛ^{μ} in a subframe is aligned in time with the start of OFDM symbols nₛ^{μ}N_{symb}^{μ} the same subframe.

Not all UEs are able to transmit and receive at the same time, and this means that not all OFDM symbols in a downlink slot or an uplink slot are available to be used.

Table 3 represents the number N_{symb}^{slot} of OFDM symbols per slot, the number Nₛₗₒₜ^{frame, μ} of slots per radio frame, and the number Nₛₗₒₜ^{subframe, μ} of slots per subframe in a normal CP. Table 4 represents the number of OFDM symbols per slot, the number of slots per radio frame, and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

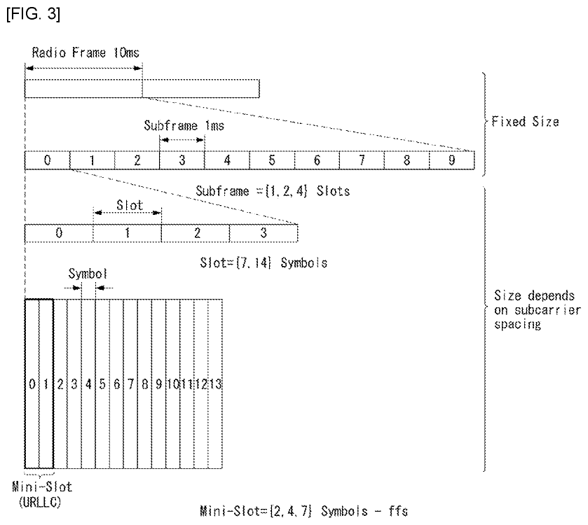

FIG. 3 illustrates an example of a frame structure in a NR system. FIG. 3 is merely for convenience of explanation and does not limit the scope of the disclosure.

In Table 4, in case of μ=2, i.e., as an example in which a subcarrier spacing (SCS) is 60 kHz, one subframe (or frame) may include four slots with reference to Table 3, and one subframe={1, 2, 4} slots shown in FIG. 3, for example, the number of slot(s) that may be included in one subframe may be defined as in Table 3.

Further, a mini-slot may consist of 2, 4, or 7 symbols, or may consist of more symbols or less symbols.

In regard to physical resources in the NR system, an antenna port, a resource grid, a resource element, a resource block, a carrier part, etc. May be considered.

Hereinafter, the above physical resources that may be considered in the NR system are described in more detail.

First, in regard to an antenna port, the antenna port is defined so that a channel over which a symbol on an antenna port is conveyed may be inferred from a channel over which another symbol on the same antenna port is conveyed. When large-scale properties of a channel over which a symbol on one antenna port is conveyed may be inferred from a channel over which a symbol on another antenna port is conveyed, the two antenna ports may be regarded as being in a quasi co-located or quasi co-location (QC/QCL) relation. Here, the large-scale properties may include at least one of delay spread, Doppler spread, frequency shift, average received power, and received timing.

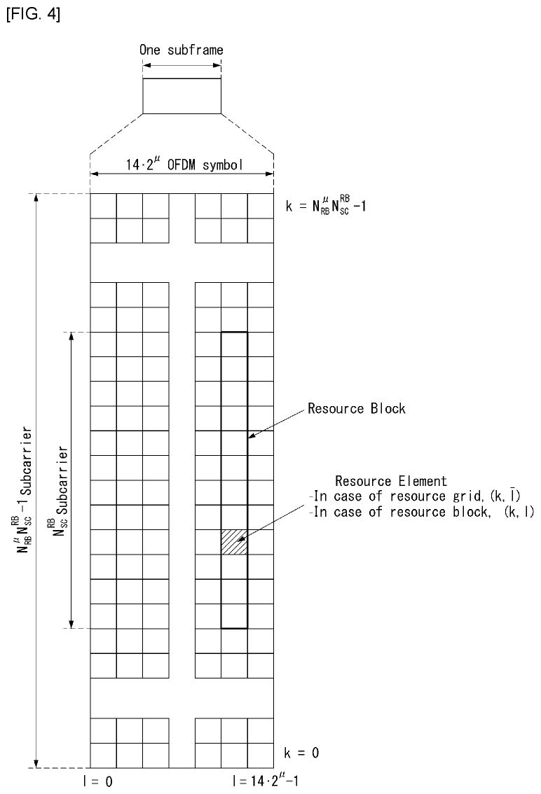

FIG. 4 illustrates an example of a resource grid supported in a wireless communication system to which a method proposed in the disclosure is applicable.

Referring to FIG. 4, a resource grid consists of N_{RB}^{μ}N_{sc}^{RB} subcarriers on a frequency domain, each subframe consisting of 14·2^{μ} OFDM symbols, but the disclosure is not limited thereto.

In the NR system, a transmitted signal is described by one or more resource grids, consisting of N_{RB}^{μ}N_{sc}^{RB} subcarriers, and 2^{μ}N_{symb}^{(μ)} OFDM symbols, where N_{RB}^{μ}≤N_{RB}^{max,μ}. N_{RB}^{max,μ} denotes a maximum transmission bandwidth and may change not only between numerologies but also between uplink and downlink.

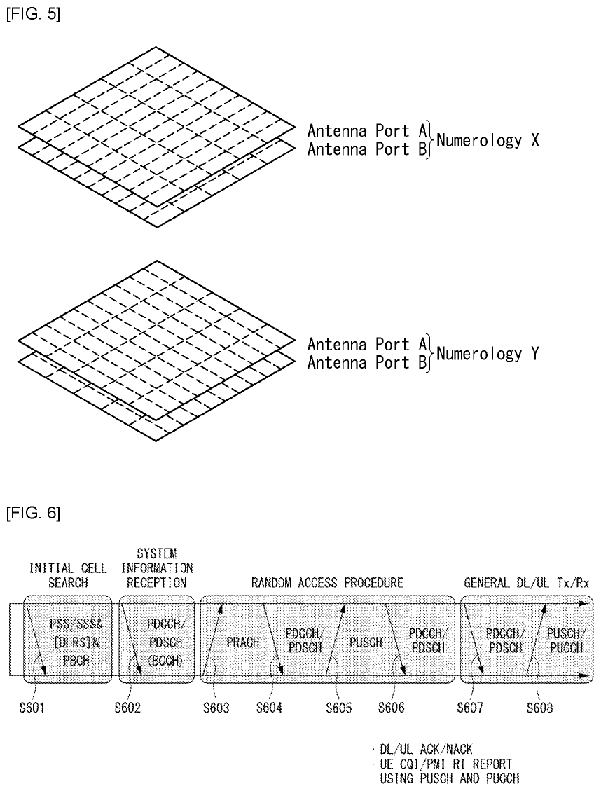

In this case, as illustrated in FIG. 5, one resource grid may be configured per numerology μ and antenna port p.

FIG. 5 illustrates examples of a resource grid per antenna port and numerology to which a method proposed in the disclosure is applicable.

Each element of the resource grid for the numerology μ and the antenna port p is called a resource element and is uniquely identified by an index pair (k,l̅), where k=0, . . . , N_{RB}^{μ}N_{sc}^{RB}−1 is an index on a frequency domain, and l̅=0, . . . 2^{μ}N_{symb}^{(μ)}−1 refers to a location of a symbol in a subframe. The index pair (k,l) is used to refer to a resource element in a slot, where l=0, . . . , N_{symb}^{μ}−1.

The resource element (k,l̅) for the numerology μ and the antenna port p corresponds to a complex value a_{k,l̅}^{(p,μ)}. When there is no risk for confusion or when a specific antenna port or numerology is not specified, the indices p and μ may be dropped, and as a result, the complex value may be a_{k,l̅}^{(p)} or a_{k,l̅}.

Further, a physical resource block is defined as N_{sc}^{BC}=12 consecutive subcarriers in the frequency domain.

Point A serves as a common reference point of a resource block grid and may be obtained as follows.
offsetToPointA for PCell downlink represents a frequency offset between the point A and a lowest subcarrier of a lowest resource block that overlaps a SS/PBCH block used by the UE for initial cell selection, and is expressed in units of resource blocks assuming 15 kHz subcarrier spacing for FR1 and 60 kHz subcarrier spacing for FR2;
absoluteFrequencyPointA represents frequency-location of the point A expressed as in absolute radio-frequency channel number (ARFCN);

The common resource blocks are numbered from 0 and upwards in the frequency domain for subcarrier spacing configuration μ.

The center of subcarrier 0 of common resource block 0 for the subcarrier spacing configuration μ coincides with “point A”. A common resource block number n_{CRB}^{μ} in the frequency domain and resource elements (k, l) for the subcarrier spacing configuration μ may be given by the following Equation 1.

$${n}_{CRB}^{μ} = ⌊ \frac{k}{{N}_{s c}^{RB}} ⌋ \qquad [ Equation 1 ]$$

Here, k may be defined relative to the point A so that k=0 corresponds to a subcarrier centered around the point A. Physical resource blocks are defined within a bandwidth part (BWP) and are numbered from 0 to N_{BWP,i}^{size}−1, where i is No. Of the BWP. A relation between the physical resource block n_{PRB} in BWP i and the common resource block n_{CRB} may be given by the following Equation 2.

n_{CRB}=n_{PRB}+N_{BWP,i}^{start} [Equation 2]

Here, N_{BWP,i}^{start} may be the common resource block where the BWP starts relative to the common resource block 0.

Physical Channel and General Signal Transmission

FIG. 6 illustrates physical channels and general signal transmission used in a 3GPP system. In a wireless communication system, the UE receives information from the eNB through Downlink (DL) and the UE transmits information from the eNB through Uplink (UL). The information which the eNB and the UE transmit and receive includes data and various control information and there are various physical channels according to a type/use of the information which the eNB and the UE transmit and receive.

When the UE is powered on or newly enters a cell, the UE performs an initial cell search operation such as synchronizing with the eNB (S601). To this end, the UE may receive a Primary Synchronization Signal (PSS) and a (Secondary Synchronization Signal (SSS) from the eNB and synchronize with the eNB and acquire information such as a cell ID or the like. Thereafter, the UE may receive a Physical Broadcast Channel (PBCH) from the eNB and acquire in-cell broadcast information. Meanwhile, the UE receives a Downlink Reference Signal (DL RS) in an initial cell search step to check a downlink channel status.

A UE that completes the initial cell search receives a Physical Downlink Control Channel (PDCCH) and a Physical Downlink Control Channel (PDSCH) according to information loaded on the PDCCH to acquire more specific system information (S602).

Meanwhile, when there is no radio resource first accessing the eNB or for signal transmission, the UE may perform a Random Access Procedure (RACH) to the eNB (S603 to S606). To this end, the UE may transmit a specific sequence to a preamble through a Physical Random Access Channel (PRACH) (S603 and S605) and receive a response message (Random Access Response (RAR) message) for the preamble through the PDCCH and a corresponding PDSCH. In the case of a contention based RACH, a Contention Resolution Procedure may be additionally performed (S606).

The UE that performs the above procedure may then perform PDCCH/PDSCH reception (S607) and Physical Uplink Shared Channel (PUSCH)/Physical Uplink Control Channel (PUCCH) transmission (S608) as a general uplink/downlink signal transmission procedure. In particular, the UE may receive Downlink Control Information (DCI) through the PDCCH. Here, the DCI may include control information such as resource allocation information for the UE and formats may be differently applied according to a use purpose.

Meanwhile, the control information which the UE transmits to the eNB through the uplink or the UE receives from the eNB may include a downlink/uplink ACK/NACK signal, a Channel Quality Indicator (CQI), a Precoding Matrix Index (PMI), a Rank Indicator (RI), and the like. The UE may transmit the control information such as the CQI/PMI/RI, etc., through the PUSCH and/or PUCCH.

CSI Related Operation

In a New Radio (NR) system, a channel state information-reference signal (CSI-RS) is used for time and/or frequency tracking, CSI computation, layer 1 (L1)-reference signal received power (RSRP) computation, and mobility. The CSI computation is related to CSI acquisition and L1-RSRP computation is related to beam management (BM).

Channel state information (CSI) collectively refers to information that may indicate the quality of a wireless channel (or referred to as a link) formed between the UE and the antenna port.

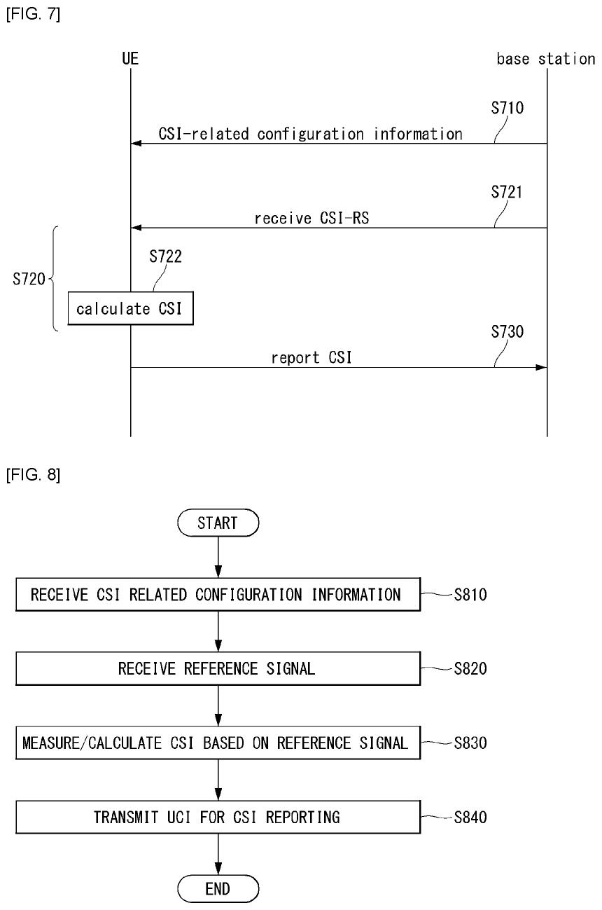

FIG. 7 is a flowchart showing an example of a CSI associated procedure to which a method proposed in the disclosure may be applied.

Referring to FIG. 7, in order to perform one of usages of the CSI-RS, a terminal (e.g., user equipment (UE)) receives, from a base station (e.g., general Node B or gNB), configuration information related to the CSI through radio resource control (RRC) signaling (S710).

The configuration information related to the CSI may include at least one of CSI-interference management (IM) resource related information, CSI measurement configuration related information, CSI resource configuration related information, CSI-RS resource related information, or CSI reporting configuration related information.

The CSI-IM resource related information may include CSI-IM resource information, CSI-IM resource set information, and the like. The CSI-IM resource set is identified by a CSI-IM resource set identifier (ID) and one resource set includes at least one CSI-IM resource. Each CSI-IM resource is identified by a CSI-IM resource ID.

The CSI resource configuration related information defines a group including at least one of a non-zero power (NZP) CSI-RS resource set, a CSI-IM resource set, or a CSI-SSB resource set. In other words, the CSI resource configuration related information may include a CSI-RS resource set list and the CSI-RS resource set list may include at least one of a NZP CSI-RS resource set list, a CSI-IM resource set list, or a CSI-SSB resource set list. The CSI-RS resource set is identified by a CSI-RS resource set ID and one resource set includes at least one CSI-RS resource. Each CSI-RS resource is identified by a CSI-RS resource ID.

Table 5 shows an example of NZP CSI-RS resource set IE. As shown in Table 5, parameters (e.g., a BM related “repetition” parameter and a tracking related “trs-Info” parameter) representing the usage may be configured for each NZP CSI-RS resource set.

```
TABLE 5
  -- ASN1START
  -- TAG-NZP-CSI-RS-RESOURCESET-START
```

| | |
|---|---|
| NZP-CSI-RS-ResourceSet ::= | SEQUENCE { |
| nzp-CSI-ResourceSetId | NZP-CSI-RS-ResourceSetId, |
| nzp-CSI-RS-Resources | SEQUENCE (SIZE (1..maxNrofNZP-CSI-RS- |

ResourcesPerSet)) OF NZP-CSI-RS-ResourceId,

| | |
|---|---|
| repetition | ENUMERATED { on, off } |
| aperiodicTriggeringOffset | INTEGER (0..4) |
| trs-Info | ENUMERATED {true} |

```
    ...
  }
  -- TAG-NZP-CSI-RS-RESOURCESET-STOP
  -- ASN1STOP
```

In addition, the repetition parameter corresponding to the higher layer parameter corresponds to “CSI-RS-ResourceRep” of L1 parameter.

The CSI reporting configuration related information includes a reportConfigType parameter representing a time domain behavior and a reportQuantity parameter representing a CSI related quantity for reporting. The time domain behavior may be periodic, aperiodic, or semi-persistent.

The CSI reporting configuration related information may be expressed as CSI-ReportConfig IE and Table 6 below shows an example of CSI-ReportConfig IE.

TABLE 6

| | |
|---|---|
| -- | ASN1START |
| -- | TAG-CSI-RESOURCECONFIG-START |

| | |
|---|---|
| CSI-ReportConfig ::= | SEQUENCE { |

| reportConfigId | CSI-ReportConfigId | |
|---|---|---|
| carrier | ServCellIndex | OPTIONAL, - |

- Need S

| resourcesForChannelMeasurement | CSI-ResourceConfigId, | |
|---|---|---|
| csi-IM-ResourcesForInterference | CSI-ResourceConfigId | OPTIONAL, - |

- Need R

| | | |
|---|---|---|
| nzp-CSI-RS-ResourcesForInterference | CSI-ResourceConfigId | OPTIONAL, - |

- Need R

| | |
|---|---|
| reportConfigType | CHOICE { |

| | |
|---|---|
| periodic | SEQUENCE { |

| | |
|---|---|
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource

| }, | |
|---|---|
| semiPersistentOnPUCCH | SEQUENCE { |

| | |
|---|---|
| reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource

| }, | |
|---|---|
| semiPersistentOnPUSCH | SEQUENCE { |

| | |
|---|---|
| reportSlotConfig | ENUMERATED {s15, s110, s120, |

s140, s180, s1160, s1320],

| | |
|---|---|
| reportSlotOffsetList | SEQUENCE (SIZE (1.. maxNrofUL- |

| Allocations)) OF INTEGER(0..32), | | |
|---|---|---|
| | p0alpha | P0-PUSCH-AlphaSetId |

| }, | |
|---|---|
| aperiodic | SEQUENCE { |

| | |
|---|---|
| reportSlotOffsetList | SEQUENCE (SIZE (1. .maxNrofUL- |

Allocations)) OF INTEGER(0..32),

| | | } | | | | |
|---|---|---|---|---|---|---|
| | }, | | | | | |
| | reportQuantity | | | CHOICE { | | |
| | | none | | | NULL, | |
| | | cri-RI-PMI-CQI | | | NULL, | |
| | | cri-RI-i1 | | | NULL, | |
| | | cri-RI-i1-CQI | | | SEQUENCE { | |
| | | | pdsch-BundleSizeForCSI | | | ENUMERATED {n2, n4} |
| OPTIONAL | | | | | | |

| }, | |
|---|---|
| cri-RI-CQI | NULL, |
| cri-RSRP | NULL, |
| ssb-Index-RSRP | NULL, |
| cri-RI-LI-PMI-CQI | NULL |

},

The UE measures CSI based on configuration information related to the CSI (S720). The CSI measurement may include (1) a CSI-RS reception process (S721) and (2) a process of computing the CSI through the received CSI-RS (S722). And, detailed descriptions thereof will be described later.

For the CSI-RS, resource element (RE) mapping is configured time and frequency domains by higher layer parameter CSI-RS-ResourceMapping.

Table 7 shows an example of CSI-RS-ResourceMapping IE.

```
    -- ASN1START
  -- TAG-CSI-RS-RESOURCEMAPPING-START
```

| | |
|---|---|
| CSI-RS-ResourceMapping ::= | SEQUENCE { |
| frequencyDomainAllocation | CHOICE { |
| row1 | BIT STRING (SIZE (4)), |
| row2 | BIT STRING (SIZE (12)), |
| row4 | BIT STRING (SIZE (3)), |
| other | BIT STRING (SIZE (6)) |

},

| | |
|---|---|
| nrofPorts | ENUMERATED {p1,p2,p4,p8,p12,p16,p24,p32}, |
| firstOFDMSymbolInTimeDomain | INTEGER (0..13), |
| firstOFDMSymbolInTimeDomain2 | INTEGER (2..12) |
| cdm-Type | ENUMERATED {noCDM, fd-CDM2, cdm4-FD2-TD2, cdm8- |

FD2-TD4},

| | |
|---|---|
| density | CHOICE { |
| dot5 | ENUMERATED (evenPRBs, oddPRBs), |
| one | NULL, |
| three | NULL, |
| spare | NULL |
| }, | |
| freqBand | CSI-FrequencyOccupation, |
| ... | |

}

In Table 7, a density (D) represents a density of the CSI-RS resource measured in RE/port/physical resource block (PRB) and nrofPorts represents the number of antenna ports.

The UE reports the measured CSI to the eNB (S730).

Here, in the case where a quantity of CSI-ReportConfig of Table 7 is configured to “none (or No report)”, the UE may skip the report.

However, even in the case where the quantity is configured to “none (or No report)”, the UE may report the measured CSI to the eNB.

The case where the quantity is configured to “none (or No report)” is a case of triggering aperiodic TRS or a case where repetition is configured.

Here, only in a case where the repetition is configured to “ON”, the UE may be skip the report.

CSI Measurement

The NR system supports more flexible and dynamic CSI measurement and reporting. The CSI measurement may include a procedure of acquiring the CSI by receiving the CSI-RS and computing the received CSI-RS.

As time domain behaviors of the CSI measurement and reporting, aperiodic/semi-persistent/periodic channel measurement (CM) and interference measurement (IM) are supported. A 4 port NZP CSI-RS RE pattern is used for configuring the CSI-IM.

CSI-IM based IMR of the NR has a similar design to the CSI-IM of the LTE and is configured independently of ZP CSI-RS resources for PDSCH rate matching. In addition, in ZP CSI-RS based IMR, each port emulates an interference layer having (a preferable channel and) precoded NZP CSI-RS. This is for intra-cell interference measurement with respect to a multi-user case and primarily targets MU interference.

The eNB transmits the precoded NZP CSI-RS to the UE on each port of the configured NZP CSI-RS based IMR.

The UE assumes a channel/interference layer for each port and measures interference.

In respect to the channel, when there is no PMI and RI feedback, multiple resources are configured in a set and the base station or the network indicates a subset of NZP CSI-RS resources through the DCI with respect to channel/interference measurement.

Resource setting and resource setting configuration will be described in more detail.

Resource Setting

Each CSI resource setting “CSI-ResourceConfig” includes a configuration for S≥1 CSI resource set (given by higher layer parameter csi-RS-ResourceSetList). Here, the CSI resource setting corresponds to the CSI-RS-resourcesetlist. Here, S represents the number of configured CSI-RS resource sets. Here, the configuration for S≥1 CSI resource set includes each CSI resource set including CSI-RS resources (constituted by NZP CSI-RS or CSI IM) and an SS/PBCH block (SSB) resource used for L1-RSRP computation.

Each CSI resource setting is positioned in a DL BWP (bandwidth part) identified by a higher layer parameter bwp-id. In addition, all CSI resource settings linked to CSI reporting setting have the same DL BWP.

A time domain behavior of the CSI-RS resource within the CSI resource setting included in CSI-ResourceConfig IE is indicated by higher layer parameter resourceType and may be configured to be aperiodic, periodic, or semi-persistent. The number S of configured CSI-RS resource sets is limited to “1” with respect to periodic and semi-persistent CSI resource settings. Periodicity and slot offset which are configured are given in numerology of associated DL BWP as given by bwp-id with respect to the periodic and semi-persistent CSI resource settings.

When the UE is configured as multiple CSI-ResourceConfigs including the same NZP CSI-RS resource ID, the same time domain behavior is configured with respect to CSI-ResourceConFIG.

When the UE is configured as multiple CSI-ResourceConfigs including the same CSI-IM resource ID, the same time domain behavior is configured with respect to CSI-ResourceConFIG.

Next, one or more CSI resource settings for channel measurement (CM) and interference measurement (IM) are configured through higher layer signaling.
CSI-IM resource for interference measurement.
NZP CSI-RS resource for interference measurement.
NZP CSI-RS resource for channel measurement.

That is, channel measurement resource (CMR) may be NZP CSI-RS and interference measurement resource (IMR) may be NZP CSI-RS for CSI-IM and IM.

Here, CSI-IM (or ZP CSI-RS for IM) is primarily used for inter-cell interference measurement.

In addition, NZP CSI-RS for IM is primarily used for intra-cell interference measurement from multi-users.

The UE may assume CSI-RS resource(s) for channel measurement and CSI-IM/NZP CSI-RS resource(s) for interference measurement configured for one CSI reporting are “QCL-TypeD” for each resource.

Resource Setting Configuration

As described, the resource setting may mean a resource set list.

In each trigger state configured by using higher layer parameter CSI-AperiodicTriggerState with respect to aperiodic CSI, each CSI-ReportConfig is associated with one or multiple CSI-ReportConfigs linked to the periodic, semi-persistent, or aperiodic resource setting.

One reporting setting may be connected with a maximum of three resource settings.
When one resource setting is configured, the resource setting (given by higher layer parameter resourcesForChannelMeasurement) is used for channel measurement for L1-RSRP computation.
When two resource settings are configured, a first resource setting (given by higher layer parameter resourcesForChannelMeasurement) is used for channel measurement and a second resource setting (given by csi-IM-ResourcesForinterference or nzp-CSI-RS-ResourcesForinterference) is used for interference measurement performed on CSI-IM or NZP CSI-RS.
When three resource settings are configured, a first resource setting (given by resourcesForChannelMeasurement) is for channel measurement, a second resource setting (given by csi-IM-ResourcesForinterference) is for CSI-IM based interference measurement, and a third resource setting (given by nzp-CSI-RS-ResourcesForinterference) is for NZP CSI-RS based interference measurement.

Each CSI-ReportConfig is linked to periodic or semi-persistent resource setting with respect to semi-persistent or periodic CSI.
When one resource setting (given by resourcesForChannelMeasurement) is configured, the resource setting is used for channel measurement for L1-RSRP computation.
When two resource settings are configured, a first resource setting (given by resourcesForChannelMeasurement) is used for channel measurement and a second resource setting (given by higher layer parameter csi-IM-ResourcesForinterference) is used for interference measurement performed on CSI-IM.

CSI Computation

When interference measurement is performed on CSI-IM, each CSI-RS resource for channel measurement is associated with the CSI-IM resource for each resource by an order of CSI-RS resources and CSI-IM resources within a corresponding resource set. The number of CSI-RS resources for channel measurement is equal to the number of CSI-IM resources.

In addition, when the interference measurement is performed in the NZP CSI-RS, the UE does not expect to be configured as one or more NZP CSI-RS resources in the associated resource set within the resource setting for channel measurement.

A UE in which Higher layer parameter nzp-CSI-RS-ResourcesForinterference is configured does not expect that 18 or more NZP CSI-RS ports will be configured in the NZP CSI-RS resource set.

For CSI measurement, the UE assumes the followings.
Each NZP CSI-RS port configured for interference measurement corresponds to an interference transport layer.
In all interference transport layers of the NZP CSI-RS port for interference measurement, an energy per resource element (EPRE) ratio is considered.
Different interference signals on RE(s) of the NZP CSI-RS resource for channel measurement, the NZP CSI-RS resource for interference measurement, or CSI-IM resource for interference measurement.

CSI Reporting

For CSI reporting, time and frequency resources which may be used by the UE are controlled by the eNB.

The channel state information (CSI) may include at least one of a channel quality indicator (CQI), a precoding matrix indicator (PMI), a CSI-RS resource indicator (CRI), an SS/PBCH block resource indicator (SSBRI), a layer indicator (LI), a rank indicator (RI), and L1-RSRP.

For the CQI, PMI, CRI, SSBRI, LI, RI, and L1-RSRP, the UE is configured by a higher layer as N≥1 CSI-ReportConfig reporting setting, M≥1 CSI-ResourceConfig resource setting, and a list (provided by aperiodicTriggerStateList and semiPersistentOnPUSCH) of one or two trigger states. In the aperiodicTriggerStateList, each trigger state includes the channel and an associated CSI-ReportConfigs list optionally indicating resource set IDs for interference. In the semiPersistentOnPUSCH-TriggerStateList, each trigger state includes one associated CSI-ReportConFIG.

In addition, the time domain behavior of CSI reporting supports periodic, semi-persistent, and aperiodic.

i) The periodic CSI reporting is performed on short PUCCH and long PUCCH. The periodicity and slot offset of the periodic CSI reporting may be configured through RRC and refer to the CSI-ReportConfig IE.

ii) SP CSI reporting is performed on short PUCCH, long PUCCH, or PUSCH.

In the case of SP CSI on the short/long PUCCH, the periodicity and the slot offset are configured as the RRC and the CSI reporting to separate MAC CE/DCI is activated/deactivated.

In the case of the SP CSI on the PUSCH, the periodicity of the SP CSI reporting is configured through the RRC, but the slot offset is not configured through the RRC and the SP CSI reporting is activated/deactivated by DCI (format 0_1). Separated RNTI (SP-CSI C-RNTI) is used with respect to the SP CSI reporting on the PUSCH.

An initial CSI reporting timing follows a PUSCH time domain allocation value indicated in the DCI and a subsequent CSI reporting timing follows a periodicity configured through the RRC.

DCI format 0_1 may include a CSI request field and may activate/deactivate a specific configured SP-CSI trigger state. SP CSI reporting has activation/deactivation which is the same as or similar to a mechanism having data transmission on SPS PUSCH.

iii) aperiodic CSI reporting is performed on a PUSCH and triggered by DCI. In this case, information related to trigger of aperiodic CSI reporting may be transferred/instructed/configured through MAC-CE.

In the case of AP CSI having an AP CSI-RS, AP CSI-RS timing is set by RRC, and timing for AP CSI reporting is dynamically controlled by DCI.

The NR does not adopt a scheme (for example, transmitting RI, WB PMI/CQI, and SB PMI/CQI in order) of dividing and reporting the CSI in multiple reporting instances applied to PUCCH-based CSI reporting in the LTE. Instead, the NR restricts specific CSI reporting not to be configured in the short/long PUCCH and a CSI omission rule is defined. In addition, in relation with the AP CSI reporting timing, a PUSCH symbol/slot location is dynamically indicated by the DCI. In addition, candidate slot offsets are configured by the RRC. For the CSI reporting, slot offset(Y) is configured for each reporting setting. For UL-SCH, slot offset K2 is configured separately.

Two CSI latency classes (low latency class and high latency class) are defined in terms of CSI computation complexity. The low latency CSI is a WB CSI that includes up to 4 ports Type-I codebook or up to 4-ports non-PMI feedback CSI. The high latency CSI refers to CSI other than the low latency CSI. For a normal UE, (Z, Z′) is defined in a unit of OFDM symbols. Here, Z represents a minimum CSI processing time from the reception of the aperiodic CSI triggering DCI to the execution of the CSI reporting. And, Z′ represents a minimum CSI processing time from the reception of the CSI-RS for channel/interference to the execution of the CSI reporting.

Additionally, the UE reports the number of CSIs which may be simultaneously calculated.

CSI Reporting Using PUSCH

Aperiodic CSI reporting performed on PUSCH supports broadband and subband frequency granularity. Aperiodic CSI reporting performed on PUSCH supports type I and type II CSI.

SP CSI reporting for PUSCH supports type I and type II CSI with wide band and subband frequency granularity. PUSCH resources and modulation and coding scheme (MCS) for SP CSI reporting are semi-permanently allocated by UL DCI.

The CSI report for PUSCH may include part 1 and part 2. Part 1 is used to identify the number of bits of the part 2 information. Part 1 is fully delivered before part 2.
Regarding type I CSI feedback, part 1 includes RI (if reported), CRI (if reported), and CQI of the first code word. Part 2 includes PMI, and when RI>4, part 2 includes CQI.
For Type II CSI feedback, part 1 has a fixed payload size and includes an indication (NIND) indicating the number of non-zero broadband amplitude coefficients for each layer of RI, CQI, and type II CSI. Part 2 includes the PMI of type II CSI.

When the CSI report includes two parts in the PUSCH and the CSI payload is smaller than the payload size provided by the PUSCH resource allocated for CSI reporting, the UE may omit a part of the second CSI. Part 2 CSI omission is determined according to priority. Priority 0 is the highest priority, and 2N_{Rep} is the lowest priority.

CSI Reporting Using PUCCH

The UE may be configured with a plurality of periodic CSI reports corresponding to the CSI report configuration indication composed of one or more higher layers. Here, the associated CSI measurement link and CSI resource configuration are configured via a higher layer.

Periodic CSI reporting in PUCCH format 2, 3 or 4 supports type I CSI based on a wide bandwidth.

Regarding the SP CSI on the PUSCH, the UE transmits the HARQ-ACK corresponding to the PDSCH carrying the selection command in slot n and then performs SP CSI reporting on the PUCCH in slot n+3Nₛₗₒₜ^{subframe,μ}+1.

The selection command includes one or more report setting indications where the associated CSI resource setting is configured.

The SP CSI report supports type I CSI in PUCCH.

The SP CSI report of PUCCH format 2 supports type I CSI with wide bandwidth frequency granularity. The SP CSI report of PUCCH format 3 or 4 supports type I sub-band CSI and type II CSI with wide bandwidth granularity.

When PUCCH carries type I CSI with wide bandwidth frequency granularity, the CSI payload carried by PUCCH format 2 and PUCCH format 3 or 4 is the same as CRI (when reported) regardless of RI.

In PUCCH format 3 or 4, the type I CSI subband payload is divided into two parts.

The first part (part 1) includes the RI of the first code word, the (reported) CRI, and the (reported) CQI. PMI is included in the second part (part 2), and when RI>4, the CQI of the second code word is included in the second part (part 2).

SP CSI reporting performed in PUCCH format 3 or 4 supports type II CSI feedback, but only part 1 of type II CSI feedback.

In PUCCH format 3 or 4 supporting type II CSI feedback, CSI reporting may depend on UE performance.

The type II CSI report (only Part 1 of them) delivered in PUCCH format 3 or 4 is calculated independently from the type II CSI report performed on the PUSCH.

When the UE is configured with CSI reporting in PUCCH format 2, 3 or 4, each PUCCH resource is configured for each candidate UL BWP.

When the UE receives the active SP CSI reporting configuration on the PUCCH and does not receive a deactivation command, CSI reporting is performed when the CSI reported BWP is an active BWP, otherwise CSI reporting is temporarily stopped. This operation is also applied in the case of SP CSI of PUCCH. For the PUSCH-based SP CSI report, the CSI report is automatically deactivated when a BWP switch occurs.

Depending on the length of the PUCCH transmission, the PUCCH format may be classified as a short PUCCH or a long PUCCH. PUCCH formats 0 and 2 may be referred to as short PUCCHs, and PUCCH formats 1, 3 and 4 may be referred to as long PUCCHs.

In relation to PUCCH-based CSI reporting, short PUCCH-based CSI reporting and long PUCCH-based CSI reporting are described in detail below.

Short PUCCH-based CSI reporting is used only for wideband CSI reporting. Short PUCCH-based CSI reporting has the same payload regardless of the RI/CRI of a given slot to avoid blind decoding.

The size of the information payload may be different between the maximum CSI-RS ports of the CSI-RS configured in the CSI-RS resource set.

When the payload including PMI and CQI is diversified to include RI/CQI, padding bits are added to RI/CRI/PMI/CQI before the encoding procedure for equalizing payloads associated with other RI/CRI values. Further, RI/CRI/PMI/CQI may be encoded as padding bits as needed.

In the case of broadband reporting, long PUCCH-based CSI reporting may use the same solution as short PUCCH-based CSI reporting.

Long PUCCH-based CSI reporting uses the same payload regardless of RI/CRI. For subband reporting, two-part encoding (for type I) is applied.

Part 1 may have a fixed payload according to the number of ports, CSI type, or RI restrictions, and part 2 may have various payload sizes according to part 1.

CSI/RI may be first encoded to determine the payload of the PMI/CQI. Further, CQIi (i=1, 2) corresponds to the CQI for the i-th code word (CW).

For long PUCCH, type II CSI report may only carry part 1.

What has been described above (e.g., 3GPP system and CSI-related operations) may be applied in combination with the methods proposed in the disclosure or may be added up to clarify the technical characteristics of the methods proposed in the disclosure.

In the disclosure, ‘A/B’ may mean including both A and B or including either A or B. For ease of description, the following terms are used throughout the disclosure. However, these terms do not limit the technical scope of the disclosure.
CSI: channel state information
UCI: uplink control information
DFT: Discrete Fourier Transform
DCT: Discrete cosine transform
LC: linear combination
WB: wideband
SB: subband
SD: spatial domain
FD: frequency domain
CQI: channel quality information
RI: rank indicator

High-resolution feedback methods, such as linear combination (LC) or covariance matrix feedback, for channel state information (CSI) accurate and efficient in light of feedback overhead in the wireless communication environment are being considered. In particular, the new RAT (NR) system considers the ‘DFT-based compression’ scheme described in Table 8 in a manner of combining (e.g., combining beams based on the amplitude and/or phase) beams with a subband (SB) for W₁ constituted of L orthogonal discrete Fourier transform (DFT) beams corresponding to wideband (WB) information.

Table 8 illustrates an example of a DFT-based compression scheme as a Type II CSI overhead reduction (compression) scheme for rank 1-2.

TABLE 8
DFT-based compression

Precoders for a layer is given by size-P × N [symbol] matrix W = W₁W₂W̅_{f}^{H}
P = 2N₁N₂ = #SD dimensions
N₃ = #FD dimensions
FFS value and unit of N₃
Spatial domain (SD) compression
L spatial domain basis vectors (mapped to the two polarizations, so 2L in total)
selected
$Compression in spatial domain using {W}_{1} = [ \begin{matrix}{v}_{0} {v}_{1} … {v}_{L - 1} & 0 \\ 0 & {v}_{0} {v}_{1} … {v}_{L - 1}\end{matrix} ] , where$
{vᵢ}ᵢ₌₀^{L-1} are N₁N₂ × 1 orthogonal DFT vectors (same as Rel. 15 Type II)
Frequency-domain (FD) compression
Compression via W_{f} = [W_{f}(0), . . . , W_{f}(2L − 1)] where W_{f}(l) = [f [symbol] f [symbol] . . . f [symbol] ],
where {fₖ_{_{i,m}}} [symbol] are Mᵢ size-N₃ × 1 orthogonal DFT vectors for SD-component
i = 0, . . . , 2L − 1
Number of FD-components {Mᵢ} or Σᵢ₌₀^{2L-1}Mᵢ is configurable, FFS value range
FFS: choose one of the following alternatives
Alt1. common basis vectors: W_{f} = [f [symbol] f [symbol] . . . f [symbol] ]. i.e. Mᵢ = M∀i and {k [symbol] } [symbol] are
identical (i.e., k_{i,m} = kₘ, i = 0, . . . , 2L − 1)
Alt2. independent basis vectors: W_{f} = [W_{f}(0), . . . ,W_{f}(2L − 1)], where
W_{f}(i) = [f [symbol] f [symbol] . . . f [symbol] ], i.e. Mᵢ frequency-domain components are selected
FFS: If oversampled DFT basis or DCT basis is used instead of orthogonal DFT basis
FFS: Same or different FD-basis selection across layers
Linear combination coefficients (for a layer)
FFS if W̅₂ is composed of K = 2LM or Σᵢ₌₀^{2L-1}Mᵢ linear combination coefficients
FFS if only a subset K₀ < K of coefficients are reported (coefficients not reported are
zero).
FFS quantization/encoding/reporting structure [symbol]
indicates data missing or illegible when filed

Further, in selecting a basis/coefficient subset for a first layer, a subset design having a size of K₀ may be selected from i) an unlimited subset (size=2LM), ii) a polarization-common subset (size=LM), or iii) a restricted subset (a subset of given beams and FD criterion, size=2L+M). A value of K₀ may be represented as K₀= [symbol] β×2LM [symbol] , and here, β of two values may be supported. The value of K₀ may be selected from

$$β ∈ \{ \frac{1}{8} , \frac{1}{4} , \frac{1}{2} , \frac{3}{4} \} .$$

The UCI is constituted by two parts. Information pertaining to the number(s) of non-zero coefficients is reported in UCI part 1. This does not mean whether the information is constituted by a single value or multiple values. Further, a payload of UCI part 1 is equally maintained for different RI value(s). The bitmap is used for representing non-zero coefficient indices.

The DFT based compression scheme may be considered/referenced even in a CSI codebook design supporting multiple layers. In this regard, Type II DFT-based compression designed for a case where the RI is 1 and 2 may be extended to a case where the RI is 3 and 4 according to the following design principle. Resulting overhead of extending to the case where the RI is 3 and 4 is at least comparable with overhead when the RI is 2.

Specifically, in SD and FD basis selection of RI∈(3,4), a parameter R is layer-common and RI-common. The parameter R may be selected from the following alternatives Alt1 to Alt6 for higher layer setting of SD/FD basis parameters (L, p):
Alt1 RI-common for RI∈{1,2,3,4}, layer-common
Alt2 RI-common for RI∈{1, 2, 3, 4}, layer-/layer-group-specific
Alt3 RI-common for RI∈{3,4}, layer-common
Alt4 RI-common for RI∈{3,4}, layer-/layer-group-specific
Alt5 RI-specific for RI∈{3,4}, layer-common
Alt6 RI-specific for RI∈{3,4}, layer-/layer-group-specific
For RI=1 and 2, RI-common and layer-common setting is agreed.

A value of M (the number of FD compression units) may be

$$M = ⌈ p \times \frac{{N}_{j}}{R} ⌉ .$$

The above-described scheme indicates representing channel information using the basis or codebook, such as DFT, for information for the spatial domain (SD) and frequency domain (FD) of CSI. The size of the total feedback reported to the base station is affected by the number of combined beams, the amount of quantization for combining coefficient, and the size of the subband and, in CSI feedback, most payloads are generated when the UE reports combination coefficient information, such as \tilde{w}₂, to the base station. Here, \tilde{w}₂ is composed of linear combination coefficients for SD/FD codebooks in the DFT-based compression scheme, and may be expressed as a matrix with a size of 2L×M.

In particular, when the rank exceeds 1, the SD/FD compression codebook for each layer needs to be designated separately, or since even when the same codebook is applied to all the layers, the channel information is composed of the convolution summation of \tilde{w}₂ for the SD and FD codebooks for each layer, the channel information that needs to be fed back also linearly increases as the rank increases. Accordingly, if the CSI codebook that should support multiple layers is designed equally to the case where the RI is 1 and 2, large loss is generated in terms of a feedback payload.

The channel performance for each layer for the channel between the base station and the UE having multiple antenna ports is influenced by the eigenvalue(s) of the channel and has a different value. Here, the antenna port may be replaced with an antenna element. Hereinafter, for convenience of description, it is referred to as an antenna port. However, the use of these terms does not limit the technical scope of the disclosure. Further, the number of layers is correlated with the number of eigenvalue(s). The channel information may be expressed as the convolution summation of eigen-vector(s) corresponding to the eigenvalue(s), and the size of the eigenvalue(s) may be a reference for determining the importance in expressing the channel information. For example, although the channel information for a higher layer (e.g., layer 3) corresponding to the smallest eigenvalue is expressed by applying a channel estimation method with relatively lower accuracy compared to the channel information for a lower layer (e.g., layer 0), the loss for the overall channel accuracy may not be significant.

Accordingly, the present disclosure intends to propose a method for differentially configuring a codebook configuration parameter for each layer by considering characteristics for each RI and layer when configuring \tilde{w}₂ (a matrix of LC coefficients) and the SD/FD basis which the UE should report to the BS in Type II CSI reporting.

In the disclosure, it is assumed that the Type II CSI codebook (including the enhanced Type II CSI codebook) includes an SD basis-related matrix, an FD basis-related matrix, and a matrix of LC coefficients. Also, the matrix of LC coefficients may include amplitude coefficients and phase coefficients. The codebook may be replaced with, e.g., a precoder or a precoding matrix, and the basis may be replaced with, e.g., a basis vector or a component. For example, the codebook may be represented as w=W₁\tilde{w}₂w_{f}^{H}, where w₁ is the SD basis-related matrix, \tilde{w}₂ is the matrix of LC coefficients, and w_{f}^{H} is the FD basis-related matrix. \tilde{w}₂ may be represented by a matrix having a size of 2L×M. Here, 2L denotes the number of SD bases (where, L is the number of beam/antenna ports in SD, and the total number of SD bases may be 2L considering polarization), and M denotes the number of FD bases. Hereinafter, for convenience of description, the following description is based on the Type II CSI codebook.

<Proposal 1>

When reporting the CSI using the Type II codebook, the UE may configure the codebook including some or all of the following information for an indicated or configured RI. In other words, the codebook may be configured based on at least one of i) a parameter setting mode, ii) the number of SD bases for RI, iii) the number of FD bases for RI, or iv) the number of non-zero linear combining coefficients for RI.

i) Parameter Setting Mode

For example, the parameter setting mode may be configured to be RI-common/RI-specific. Alternatively, the parameter setting mode may be configured to be layer-common/layer or layer group specific. As an example, the parameter setting mode may be configured to be a) RI-common and layer (or layer group)-common, b) RI-common and layer (or layer group)-specific, c) RI-specific and layer (or layer group)-common, or d) RI-specific and layer (or layer group)-specific.

ii) The Number of SD Bases for RI

x [symbol] =α [symbol] x [symbol] (here, α [symbol] may be determined according to an RRC configuration or a predefined rule. Further, i means an index of a layer (hereinafter, the same is applied)).

u [symbol] for the RI-specific (here, u [symbol] may be determined according to an RRC configuration or a predefined rule. Further, r means a rank (hereinafter, the same is applied)).

iii) The Number of FD Bases for RI

y [symbol] =y [symbol] y [symbol] (here, yᵢ may be determined according to an RRC configuration or a predefined rule).

v [symbol] for the RI-specific (here, v [symbol] may be determined according to an RRC configuration or a predefined rule).

$${M}_{i} = [ {y}_{i} \times \frac{{N}_{3}}{R} ] / {M}_{r , i} = ⌈ {v}_{r , i} \times \frac{{N}_{i}}{R} ⌉ ,$$

here, Mᵢ means the number of FD components. The FD component may correspond to the FD basis.

iv) The Number of Non-Zero Linear Combining Coefficients for RI

$$\text{?} = [ β \text{?} \times 2 x \text{?} M \text{?} ] and \text{/} or β \text{?}$$

$$\text{?} \text{indicates text missing or illegible when filed}$$

β [symbol] may be configured based on the following condition: a) Σ [symbol] K [symbol] =2φK₀ or Σ [symbol] K [symbol] =2φK₀, here, φ may be configurable or predefined. b) K [symbol] =ω [symbol] K₀, here, Σ [symbol] ω [symbol] =1

For the RI-specific, x [symbol] and y [symbol] are replaced with u [symbol] and v [symbol] , respectively.

Through the proposal, the Type II CSI codebook configuration parameter is configured to effectively design channel information for a higher rank such as RI=3 or RI=4. Whether each parameter (e.g., xᵢ, yᵢ, and βᵢ, etc.) is to be applied commonly to the Ri or applied specific to specific RI) (e.g., RI is 3 or 4) may be configured/indicated. Further, a common/specific parameter may be configured, even to layers according to each RI.

A beam configuration value of a spatial domain (SD) may be determined through RRC signaling or configured according to a predefined rule considering a ratio and a specific correlation as in the contents. In other words, a parameter related to the number of SD bases may be configured through the RRC signaling or configured according to the predefined rule. In this case, DFT beams corresponding to xᵢ or uᵢ configured for each RI or layer may be independently selected.

Tables 9 to 11 show an example of a parameter configuration for each parameter setting mode for configuring the Type II CSI codebook up to RI=4 according to Proposal 1 described above. Tables 9 to 11 are just for convenience of the description and do not limit the technical scope of the present disclosure.

When the UE reports, to the BS, the parameter setting mode of Proposal 1 above, the payload for configuring the codebook may be different according to the parameter setting mode, and as a result, UCI may be designed in which the corresponding parameter setting mode is included in Part 1 CSI.

In Tables 9 to 11, L represents the number of combining beams, p represents a parameter the number of FD bases, and beta represents a parameter related to a linear combining coefficient. The parameters L and p influence the number of SD bases and the number of FD bases, respectively, and beta is correlated to a subset of coefficients to be reported. Accordingly, three parameters (e.g., L, p, and beta) becomes a main element for determining a payload for CSI feedback.

Further, the same variable (e.g., x₀ for all RIs and layers) means the same higher-layer configured value. Other variables mean a possibility for different higher layer setting values or a fixed relations (e.g., x₀ and x₂, here, x₀ and x₂ may be independently configured or x₂ may be a fixed function of x₀).

Table 9 shows an example of a parameter configuration configured as RI common and layer/layer group specific for RI∈{1, 2, 3, 4}.

TABLE 9

| RI | Layer | L | p | β |
|---|---|---|---|---|
| 1 | 0 | x₀ | y₀ | β₀ |
| 2 | 0 | | | |
| | 1 | | | |
| 3 | 0 | x₀ | y₀ | β₀ |
| | 1 | | | |
| | 2 | x₂ | y₂ | β₂ |
| 4 | 0 | x₀ | y₀ | β₀ |
| | 1 | x₂ | y₂ | β₂ |
| | 2 | x₂ | y₂ | β₂ |
| | 3 | x₃ | y₃ | β₃ |

Table 9 show an example in which a basis parameter is applied which is common to the configured RI, but a distinguished value is configured for each layer.

In this case, in supporting the case where the RI is 3 and 4, when L which is the number of SD bases is differentially configured, each of a case of configuring L to a large value or a case of configuring L to a small value based on a value of x₀ (e.g., x₀=4) when the RI is 1 and 2 needs to be considered. Specifically, by considering that the DFT based compression scheme for RI=1 and 2 to RI=3 and 4, it is necessary to configure the value of L so that the payload of the codebook in the case of RI=3 and 4 is similar to the payload when RI=2 is assumed. Accordingly, when L for supporting layers 2 and 3 is configured to a value larger than the value of x₀, there is an advantage in that a resolution of an SD beam increases, and as a result, it is necessary to configure p or beta to a relatively small value. On the contrary, when L is configured to a value smaller than the value of x₀, an effect by layer orthogonality may be expected by using a beam independent from the SD beam used in the case of RI=1 and 2, and as a result, even though values similar to p and beta values applied in L=4 in the related art are applied, a codebook design criterion for RI=3 and 4 may be satisfied.

A specific embodiment for a SD/FD basis configuration according to Proposal 9 described above will be described.

It may be assumed that values of the following parameters are configured or predefined. As an example, the following parameters may be configured from the BS.
RI=4, N3=13, R=1
[x₀, x₂, x₃]=[4,4,2]
[y₀, y₂, y₃]=[½,¼,¼]
[ω₂, ω₃]=[⅔,⅓]
β₀=½, φ=1

A calculation for acquiring βᵢ may be performed based on the parameters.
[M₀, M₂, M₃]=[7,4,4], K₀=28, K_{0,2}=⅔K₀=19, K_{0,3}=⅓K₀==9

$$- [ {β}_{2} , {β}_{3} ] = [ \frac{19}{32} , \frac{9}{16} ]$$

from the condition as Σ [symbol] K [symbol] =2φK₀

The UE may report βᵢ through an explicit method or quantization.

The parameter value of the embodiment is just an example used for convenience of description, but does not limit the technical scope of the present disclosure.

Table 10 shows an example of a parameter configuration configured as RI common and layer/layer group specific for RI∈{3, 4}.

TABLE 10

| RI | Layer | L | p | β |
|---|---|---|---|---|
| 1 | 0 | x₀ | y₀ | β₀ |
| 2 | 0 | | | |
| | 1 | | | |
| 3 | 0 | x₀ | y₀ | β₀ |
| | 1 | | | |
| | 2 | | y₀ | β₂ |
| 4 | 0 | | y₀ | β₀ |
| | 1 | | | |
| | 2 | | y₂ | β₂ |
| | 3 | | | |

Table 11 shows an example of a parameter configuration configured as RI specific and layer/layer group specific for RI∈{3, 4}.

TABLE 11

| RI | Layer | L | p | β |
|---|---|---|---|---|
| 1 | 0 | x₀ | y₀ | β₀ |
| 2 | 0 | | | |
| 3 | 0 | u_{3.0} | v_{3.0} | β_{3.0} |
| | 1 | | | |
| | 2 | u_{3.2} | | β_{3.2} |
| 4 | 0 | u_{4.0} | v_{4.0} | β_{4.0} |
| | 1 | | | |
| | 2 | u_{4.2} | | β_{4.0} |
| | 3 | u_{4.3} | | β_{4.3} |

As described above, the codebook configuration parameter may be differentially configured by considering at least one characteristic of the RI or the layer. The UCI according to the Type II CSI codebook configuration up to RI=4 is newly designed as below based on proposal to perform CSI reporting, which is flexible according to the RI configuration and effective even in terms of payload reduction.

<Proposal 2>

When the CSI is reported by using the Type II CSI codebook, in the case of Part 1 CSI and Part 2 CSI, the UCI may be constituted as blow, which includes the parameter setting mode and some or all of the information.

For example, Part 1 CSI may include at least one of the RI, the CQI, or K_{NZ,i} (the number of non-zero coefficients per layer). Part 2 CSI may include layer-common or layer/layer group-specific spatial domain (SD) beam selection W₁, per layer W₂, frequency domain (FD) basis selection per layer W_{f}, etc. Here, per layer W₂ may include a bitmap, indices of strongest coefficients, amplitude quantization per layer, phase quantization per layer, etc.

Proposal 2 above proposes a UCI design method based on a configuration for the configuration parameter of the Type II CSI codebook according to the RI (e.g., Type II CSI codebook according to RI/layer based on Proposal 1). Part 1 CSI may be configured by a value capable of determining the size of Part 2 CSI. In this case, each part according to Proposal 2 above may be constituted, which includes some or all of components in each part included in the UCI of the existing scheme.

K_{NZ,i} in Part 1 CSI may be calculated by [log₂βLM]X[max.RI] according to the parameter setting and scheme of Proposal 1. A payload size for constituting Part 2 CSI may be calculated based on the Part 1 CSI.

Part 2 CSI may include actual components for constituting an actual Type II CSI codebook. Specifically, Part 2 CSI may select the SD/FD bases according to a configured number as described above and include information on linear combining coefficients corresponding thereto. The SD beam selection may be expressed by designating the index of the actual beam by an explicit scheme or the SD beam may be selected according to a predefined rule for each RI or layer/layer group. For example, in selecting the SD beam in which RI=3 and 4, after the beam used in the case of RI=1 and 2 is excluded, the remaining beams may be selected in ascending order/descending order of indices for the remaining beams or beams 1 to n may be selected, which include the existing beam.

In the above proposal, in the SD beam selection W₁, the UCI field may be constituted by one of the following schemes. For example, as an example of the layer group specific, a case where N1=4, N2=4, RI=3, and L=4 may be considered based on Table 11 described above. In addition, it is assumed that u_{3,0}=4, u_{3,2}=2 is configured or applied. The configuration value is just an example for convenience of description, and does not limit the technical scope of the present disclosure. Accordingly, the proposal may be applied even to sizes of various configurations values and a combination of the configuration values, of course.

1. Independent Beam Selection and Indication

Beams of each of numbers of u_{3,0}=4, u_{3,2}=2 are independently selected in N1*N2 (e.g., 16) orthogonal beam sets and constitute each UCI field to be reported to the BS. In the above example, a bit-width configuration example of the UCI field for the SD beam selection may be represented by

$$⌈ {log}_{2} ( \begin{matrix}{N}_{1} {N}_{2} \\ {u}_{3 , 0}\end{matrix} ) ⌉ = ⌈ {log}_{2} ( \begin{matrix}16 \\ 4\end{matrix} ) ⌉ and$$

$$⌈ {log}_{2} ( \begin{matrix}{N}_{1} {N}_{2} \\ {u}_{3 , 2}\end{matrix} ) ⌉ = ⌈ {log}_{2} ( \begin{matrix}16 \\ 2\end{matrix} ) ⌉ .$$

### Here,

$$( \begin{matrix}a \\ b\end{matrix} )$$

is a combinatorial number, and may be calculated as ‘a choose b’ directly by the UE or used by reducing a calculation amount with a look up table.

2. Independent and Exclusive Beam Selection and Indication

Beams of each of numbers of u_{3,0}=4,u_{3,2}=2 are independently selected in N1*N2 orthogonal beam sets, and as a difference from subclause 1 described above, when a second beam set is determined, the second beam is selected without allowing redundancy with the first beam set. In this case, the bit-width configuration example of the UCI field may be represented by

$$⌈ {log}_{2} ( \begin{matrix}{N}_{1} {N}_{2} \\ {u}_{3 , 0}\end{matrix} ) ⌉ = ⌈ {log}_{2} ( \begin{matrix}16 \\ 4\end{matrix} ) ⌉ and$$

$$⌈ {log}_{2} ( \begin{matrix}{N}_{1} {N}_{2} \\ {u}_{3 , 2}\end{matrix} ) ⌉ = ⌈ {log}_{2} ( \begin{matrix}16 \\ 2\end{matrix} ) ⌉ , .$$

In the above example, when N1 and N2 are small, for example, in the case of 4 ports, since a value of N₁N₂−4 may have a negative value, the example may be limited to be used only in the case of a specific port number or more (e.g., 12 or 16 ports).

3. Common Selection for Larder Value of L and Selection within the Commonly Selected Beam Set for Smaller Value of L

u_{3,0}=4 beams are selected in N1*N2 orthogonal beam sets and the remaining sets are selected within u_{3,0} beams, and constitute the UCI field to be reported to the BS. In the above example, a bit-width configuration example of the UCI field for the SD beam selection may be represented by

$$⌈ {log}_{2} ( \begin{matrix}{N}_{1} {N}_{2} \\ {u}_{3 , 0}\end{matrix} ) ⌉ = ⌈ {log}_{2} ( \begin{matrix}16 \\ 4\end{matrix} ) ⌉ and$$

$$⌈ {log}_{2} ( \begin{matrix}{N}_{1} {N}_{2} \\ {u}_{3 , 2}\end{matrix} ) ⌉ = ⌈ {log}_{2} ( \begin{matrix}16 \\ 2\end{matrix} ) ⌉ .$$

Alternatively, overhead may be reduced by selecting only some of combinations of

$$⌈ {log}_{2} ( \begin{matrix}{u}_{30} \\ {u}_{3 , 2}\end{matrix} ) ⌉ = ⌈ {log}_{2} ( \begin{matrix}4 \\ 2\end{matrix} ) ⌉ .$$

For example, there are six beam combinations of {1, 2, 3, 4} (3 bits are required), and a scheme of pre-promising only four beam combinations such as {1, 2}, {1, 3}, {1, 4}, and {2, 3} (2 bits are required), and selecting and reporting a combination of the four combinations may also be considered.

4. Common Selection for Larder Value of L and Selection with Predefined Rule within the Commonly Selected Beam Set for Smaller Value of L

u_{3,0}=4 beams are selected in N1*N2 orthogonal beam sets and the remaining sets are selected within u_{3,0} beams by a predefined scheme, and constitute the UCI field to be reported to the BS. Accordingly, only one bit-width is required to significantly reduce the UCI overhead. For example, the bit-width configuration example of the UCI field for the SD beam selection is as follows. The second beam set

$$⌈ {log}_{2} ( \begin{matrix}{N}_{1} {N}_{2} \\ {u}_{3 , 0}\end{matrix} ) ⌉ = ⌈ {log}_{2} ( \begin{matrix}16 \\ 4\end{matrix} ) ⌉$$

may be selected among four pre-selected beam sets by the predefined/configured scheme. As an example, first two beams or last two beams may be promised/defined among first selected beams or which beams are to be selected may be signaled through the higher layer by the BS.

In the configuration per layer W₂, coefficient indices to be reported are designated by a bitmap (2LM-size), and as a result, a payload which is as large as 2LM*RI is required. In this case, when index information (e.g., ┌log₂ 2 LM┐*RI) for a strongest coefficient is utilized, the bitmap is configured based on a beam to which the corresponding coefficient belongs to effectively perform the bitmap configuration per layer. This may be reported by quantizing each coefficient constituted by complex numbers to an amplitude/phase.

As a modified example of Proposal 2, Part 2 CSI may include layer common or layer-group specific SD beam selection W₁, per layer W₂, per layer group W₂, etc. Here, per layer may include indices of strongest coefficients, amplitude quantization per layer, phase quantization per layer, etc. Per layer group W₂ may include the bitmap, FD basis selection per layer Wⱼ, etc.

The bit-width of the UCI field for the FD basis selection W_{f} may be determined by the following method. For example, a case where N1=4, N2=4, RI=3, L=4, and N3=13 may be considered based on Table 10 described above. In addition, it is assumed that y₀=½, y₂=¼=>M₀=7,M₂=4 is configured or applied. The configuration value is just an example for convenience of description, and does not limit the technical scope of the present disclosure. Accordingly, the proposal may be applied even to sizes of various configurations values and a combination of the configuration values, of course.

1. Independent Basis Selection and Indication

Bases of each of numbers of M₀=7,M₂=4 are independently selected in N3 orthogonal basis sets and constitute each field to be reported to the BS. In the above example, a bit-width configuration example of the UCI field for the FD basis selection may be represented by

$$⌈ {log}_{2} ( \begin{matrix}{N}_{3} \\ {y}_{0}\end{matrix} ) ⌉ = ⌈ {log}_{2} ( \begin{matrix}13 \\ 7\end{matrix} ) ⌉ and$$

$$⌈ {log}_{2} ( \begin{matrix}{N}_{3} \\ {y}_{2}\end{matrix} ) ⌉ = ⌈ {log}_{2} ( \begin{matrix}13 \\ 2\end{matrix} ) ⌉ .$$

### Here,

$$( \begin{matrix}a \\ b\end{matrix} )$$

is a combinatorial number, and may be calculated as ‘a choose b’ directly by the UE or used by reducing a calculation amount with a look up table.

2. Common Selection for Larger Value of p and Selection within the Commonly Selected Beam Set for Smaller Value of p

M₀=7 bases are selected in N3 orthogonal basis sets and the remaining sets are selected within M₀ selected bases, and constitute the UCI field to be reported to the BS. In the above example, a bit-width configuration example of the UCI field for the FD basis selection may be represented by

$$⌈ {log}_{2} ( \begin{matrix}{N}_{3} \\ {y}_{0}\end{matrix} ) ⌉ = ⌈ {log}_{2} ( \begin{matrix}13 \\ 7\end{matrix} ) ⌉ and$$

$$⌈ {log}_{2} ( \begin{matrix}{y}_{0} \\ {y}_{2}\end{matrix} ) ⌉ = ⌈ {log}_{2} ( \begin{matrix}7 \\ 4\end{matrix} ) ⌉ .$$

Alternatively, overhead may be reduced by selecting only some of combinations of

$$⌈ {log}_{2} ( \begin{matrix}{y}_{0} \\ {y}_{2}\end{matrix} ) ⌉ = ⌈ {log}_{2} ( \begin{matrix}7 \\ 4\end{matrix} ) ⌉ .$$

For example, there are 35 beam combinations of {1, 2, 3, 4, 5, 6, 7} (6 bits are required), and a scheme of pre-promising and reporting only 8 beam combinations (3 bits are required) among 35 beam combinations may also be considered.

3. Common Selection for Larder Value of p and Selection with Predefined Rule within the Commonly Selected Beam Set for Smaller Value of p

M₀=7 bases are selected in N3 orthogonal basis sets and the remaining sets are selected within M₀ beams, and constitute the UCI field to be reported to the BS. In the above example, the bit-width configuration example of the UCI field for the FD basis selection may be represented by

$$⌈ {log}_{2} ( \begin{matrix}{N}_{3} \\ {y}_{0}\end{matrix} ) ⌉ = ⌈ {log}_{2} ( \begin{matrix}13 \\ 7\end{matrix} ) ⌉ ,$$

and as a result, only one bit-width is required to significantly reduce the UCI overhead. In the case of the second beam set, first four or last four beams among 7 pre-selected beams may be promised or which beams may be signaled through the higher layer by the BS.

The codebook configuration parameter is differentially configured by considering at least one characteristic of the RI or the layer through the proposal methods (e.g., Proposal 1, Proposal 2, etc.), and UCI for Type II CSI reporting is newly designed to perform CSI reporting which is effective even in terms of payload reduction.

FIG. 8 is a flowchart illustrating operations of a UE reporting channel state information to which a method and/or embodiment proposed in the disclosure may be applied. FIG. 8 is intended merely for illustration purposes but not for limiting the scope of the disclosure. Referring to FIG. 8, the UE and/or base station are assumed to operate based on proposals 1 and 2 and/or embodiments described above. Further, the CSI-related operations of FIG. 7 may be referenced/used in the operations of the UE and/or the base station. Some of the steps described in FIG. 8 may be combined or omitted.

The UE may receive, from the BS, CSI related configuration information (S810). The CSI related configuration information may include codebook related information. Further, the CSI related configuration information may include information related to a rank indicator (RI). For example, the codebook related information may include information related to the codebook configuration parameter described in Proposal 1 described above.

For example, the information related to the codebook configuration parameter may include at least one of first parameter information (e.g., parameter L) related to the number of SD bases, second parameter information (e.g., parameter p) related to the number of FD bases, or third parameter information (e.g., parameter beta) related to the linear combining coefficient. A codebook may be constituted which is used for calculating the CSI based on the information related to the codebook configuration parameter.

For example, some or all of the codebook configuration parameters (e.g., L, p, beta, etc.) may be commonly applied to the RI or configured/applied to be specific to specific RI. Further, some or all of the codebook configuration parameters may be applied even to the layers according to each RI to be common/specific. As an example, some or all of the codebook configuration parameters (e.g., L, p, beta, etc.) may be configured to be one scheme of a) RI-common and layer (or layer group)-common, b) RI-common and layer (or layer group)-specific, c) RI-specific and layer (or layer group)-common, or d) RI-specific and layer (or layer group)-specific. As a specific example, second parameter information (e.g., parameter p) related to the number of FD bases may be configured based on one of the RI or the layer. As an example, the second parameter information may be configured to be different (specific) according to the RI. As an example, the first parameter information may be configured to be common (specific) to the RI.

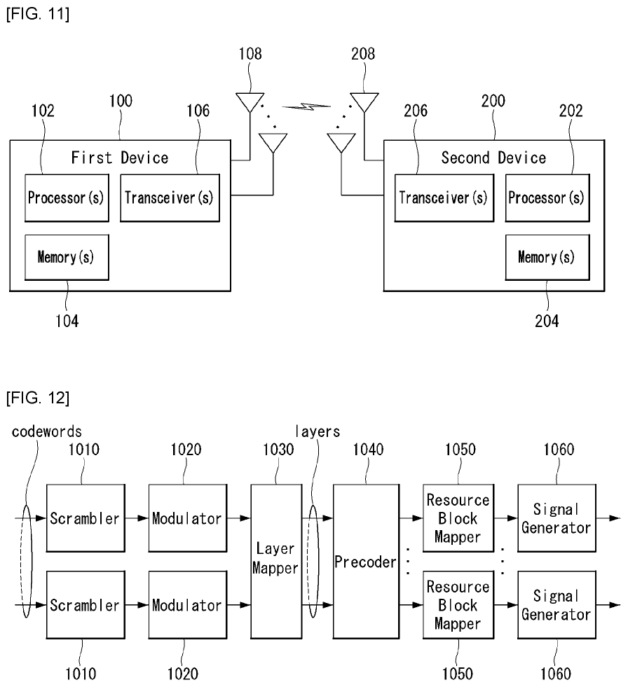

For example, the operation of receiving the CSI-related configuration information from the base station (100/200 of FIGS. 10 to 14) by the UE (100/200 of FIGS. 10 to 14) in the above-described step S810 may be implemented by a device as illustrated in FIGS. 10 to 14 described below. For example, referring to FIG. 11, one or more processors 202 may control one or more transceivers 206 and/or one or more memories 204 to receive the CSI-related configuration information, and one or more transceivers 206 may receive the CSI-related configuration information from the base station.

The UE may receive a reference signal (RS) from the base station (S820). The reference signal may be received based on the CSI-related configuration information. The reference signal may be periodically, semi-persistently, or aperiodically transmitted from the base station.

For example, the operation of receiving the reference signal from the base station (100/200 of FIGS. 10 to 14) by the UE (100/200 of FIGS. 10 to 14) in the above-described step S820 may be implemented by a device as illustrated in FIGS. 10 to 14 described below. For example, referring to FIG. 11, one or more processors 202 may control one or more transceivers 206 and/or one or more memories 204 to receive the reference signal, and one or more transceivers 206 may receive the reference signal from the base station.

The UE may perform CSI measurement/calculation based on a reference signal (S830). For example, the UE may configure/determine the codebook based on the information related to the codebook configuration information received in step S810 and measure/calculate the CSI based on the codebook. As an example, the codebook may be configured based on at least one of the layer or the rank indicator (RI).

For example, the operation of measuring/calculating the CSI based on the reference signal by the UE (100/200 of FIGS. 10 to 14) in the above-described step S830 may be implemented by a device as illustrated in FIGS. 10 to 14 described below. For example, referring to FIG. 11, one or more processors 202 may control one or more transceivers 206 and/or one or more memories 204 to measure/calculate the CSI based on the reference signal.

The UE may transmit, to the BS, uplink control information (UCI) for CSI reporting (S840). The CSI may be Type II codebook based CSI reporting. For example, an operation of transmitting the uplink control information for the CSI reporting may be performed based on the method/embodiment described in Proposal 2 described above. As an example, the CSI may include first information and second information selected based on the first information.

For example, the CSI may include at least one of spatial domain related information (e.g., SD basis), frequency domain related information (e.g., FD basis), or information (e.g., linear combining coefficient) on a non-zero linear combining coefficient. As an example, SD/FD bases of a number configured based on the codebook configuration parameter of Proposal 1 above may be selected, and information on the linear combining coefficient corresponding thereto may be included in the CSI and reported to the BS.

As a specific example, the spatial domain related information may be related to beam selection in the spatial domain. The UE may i) independently select a beam for each layer in all beam sets, ii) independently select the beam for each layer in all beam sets, but select the beam so that the beam for each layer is not duplicated, iii) select some of all beam sets (e.g., first information) and select a beam of another layer from some selected beam sets (e.g., second information), or iv) select some of all beam sets and select the beam of another layer from some selected beam sets by one method of predefined methods. As an example, a ‘combination’ scheme may be used in a beam selection process. The information for selected beam (e.g., the first information and the second information selected based on the first information) may be reported to the BS as the spatial domain related information.

As another specific example, the frequency domain related information may be related to basis selection in the frequency domain. In relation to the basis selection in the frequency domain, i) the basis may be independently selected for each layer in all basis sets, ii) some bases may be selected from all basis sets (e.g., first information) and an FD basis of another layer may be selected from some selected bases (e.g., second information), or iii) some may be selected from all basis sets, and basis selection of another layer from some selected bases may be predefined. As an example, a ‘combination’ scheme may be used in an FD basis selection process. The information for the selected FD basis (e.g., the first information and the second information selected based on the first information) may be reported to the BS as the frequency domain related information.

As yet another specific example, the information on the non-zero linear combining coefficient may include index information of a coefficient to be reported, which is expressed in a bitmap form (e.g., 2LM-size). Further, the information may be based on index information for a strongest coefficient.

The uplink control information (UCI) may include a first part (e.g., Part 1 CSI or UCI part 1) and a second part (e.g., Part 2 CSI or UCI part 2). Further, the first part may include information related to determination of a payload size of the second part. For example, the first part (e.g., Part 1 CSI) may include at least one of the RI, the CQI, or the number of non-zero coefficients per layer. The second part (e.g., Part 2 CSI) may include at least one of the SD basis, the FD basis, or information on LC coefficients. The information on the LC coefficients may include the bitmap, the indices of the strongest coefficients, information on amplitude quantization, information on phase quantization, etc.

As an example, when the UE reports, to the BS, the parameter setting mode of Proposal 1 described above, the parameter setting mode may be reported while being included in the first part (e.g., UCI part 1) of the UCI.

As an example, the frequency domain related information (e.g., the first information selected from all basis sets and the second information selected based on the first information), the spatial domain related information (e.g., the first information selected from all beam sets and the second information selected based on the first information), or the information on the non-zero linear combining coefficient may be included in the second part of the UCI. As an example, only some of the second information may also be included in the UCI.

For example, a bit width of the UCI may be determined based on the first information and the second information. As an example, the first information and the second information may be bases of the frequency domain or the spatial domain, and the bit width may be calculated from

$$⌈ {log}_{2} ( \frac{number of first information}{number of second information} ) ⌉ .$$

Here, ┌log₂(.)┐ represents a ceiling function.

For example, an operation of the UE (reference numeral 100 and/or 200 of FIGS. 10 to 14) which transmits the UCI for CSI reporting to the BS (reference numeral 100 and/or 200 of FIGS. 10 to 14) in step S840 described above may be implemented by devices of FIGS. 10 to 14 to be described below. For example, referring to FIG. 11, one or more processors 202 may control one or more transceivers 206 and/or one or more memories 204 so as to transmit the UCI for the CSI reporting, and one or more transceivers 206 may transmit the UCI for the CSI reporting to the BS.

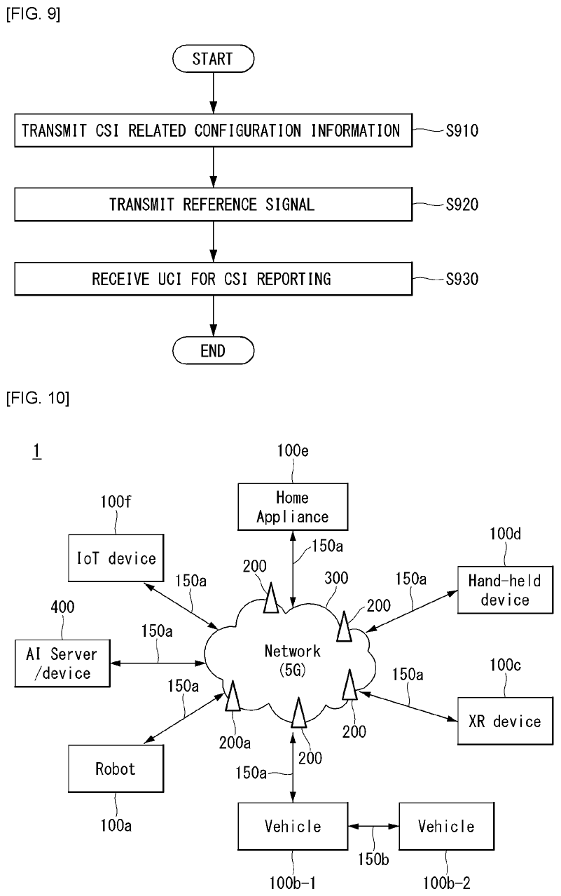

FIG. 9 is a flowchart illustrating operations of a base station receiving channel state information to which a method and/or embodiment proposed in the disclosure may be applied. FIG. 9 is intended merely for illustration purposes but not for limiting the scope of the disclosure. Referring to FIG. 9, the UE and/or base station are assumed to operate based on proposals 1 and 2 and/or embodiments described above. Further, the CSI-related operations of FIG. 7 may be referenced/used in the operations of the UE and/or the base station. Some of the steps described in FIG. 9 may be combined or omitted.

The BS may transmit, to the UE, CSI related configuration information (S910). The CSI related configuration information may include codebook related information. Further, the CSI related configuration information may include information related to a rank indicator (RI). For example, the codebook related information may include information related to the codebook configuration parameter described in Proposal 1 described above.

For example, the information related to the codebook configuration parameter may include at least one of first parameter information (e.g., parameter L) related to the number of SD bases, second parameter information (e.g., parameter p) related to the number of FD bases, or third parameter information (e.g., parameter beta) related to the linear combining coefficient. A codebook may be constituted which is used for calculating the CSI based on the information related to the codebook configuration parameter.

For example, some or all of the codebook configuration parameters (e.g., L, p, beta, etc.) may be commonly applied to the RI or configured/applied to be specific to specific RI. Further, some or all of the codebook configuration parameters may be applied even to the layers according to each RI to be common/specific. As an example, some or all of the codebook configuration parameters (e.g., L, p, beta, etc.) may be configured to be one scheme of a) RI-common and layer (or layer group)-common, b) RI-common and layer (or layer group)-specific, c) RI-specific and layer (or layer group)-common, or d) RI-specific and layer (or layer group)-specific. As a specific example, parameter information (e.g., parameter p and second parameter information) related to the number of FD bases may be configured to be different (specific) according to the RI.

For example, an operation of the BS (reference numeral 100 and/or 200 of FIGS. 10 to 14) which transmits the CSI related configuration information to the UE (reference numeral 100 and/or 200 of FIGS. 10 to 14) in step S910 described above may be implemented by the devices of FIGS. 10 to 14 to be described below. For example, referring to FIG. 11, one or more processors 202 may control one or more transceivers 206 and/or one or more memories 204 so as to transmit the CSI related configuration information, and one or more transceivers 206 may transmit the CSI related configuration information to the UE.

The base station may transmit a reference signal (RS) to the UE (S920). The reference signal may be transmitted based on the CSI-related configuration information. The reference signal may be periodically, semi-persistently, or aperiodically transmitted from the base station.

For example, the operation of transmitting the reference signal to the UE (100/200 of FIGS. 10 to 14) by the base station (100/200 of FIGS. 10 to 14) in the above-described step S920 may be implemented by a device as illustrated in FIGS. 10 to 14 described below. For example, referring to FIG. 11, one or more processors 202 may control one or more transceivers 206 and/or one or more memories 204 to transmit the reference signal, and one or more transceivers 206 may transmit the reference signal to the UE.

The BS may receive, from the UE, uplink control information (UCI) for CSI reporting (S930). The CSI may be Type II codebook based CSI reporting.

For example, the CSI may include at least one of spatial domain related information (e.g., SD basis), frequency domain related information (e.g., FD basis), or information (e.g., linear combining coefficient) on a non-zero linear combining coefficient. As an example, SD/FD bases of a number configured based on the codebook configuration parameter of Proposal 1 above may be selected, and information on the linear combining coefficient corresponding thereto may be included in the CSI.

As a specific example, the spatial domain related information may be related to beam selection in the spatial domain. The BS may receive, from the UE, UCI including some beam sets (e.g., first information) selected from all beam sets and beam information (e.g., second information) of another layer selected from some beam sets (e.g., first information). As an example, a ‘combinatorial number’ scheme may be used in a beam selection process.

As another specific example, the frequency domain related information may be related to basis selection in the frequency domain. In relation to the basis selection in the frequency domain, i) the basis may be independently selected for each layer in all basis sets, ii) some bases may be selected from all basis sets (e.g., first information) and an FD basis of another layer may be selected from some selected bases (e.g., second information), or iii) some may be selected from all basis sets, and basis selection of another layer from some selected bases may be predefined. As an example, a ‘combinatorial number’ scheme may be used in an FD basis selection process. The BS may receive, from the UE, information on a selected FD basis as the frequency domain related information. As an example, the BS may receive, from the UE, UCI including some basis sets (e.g., first information) selected from all basis sets and a basis (e.g., second information) selected from some basis sets (e.g., first information).

As yet another specific example, the information on the non-zero linear combining coefficient may include index information of a coefficient to be reported, which is expressed in a bitmap form (e.g., 2LM-size). Further, the information may be based on index information for a strongest coefficient.

The uplink control information (UCI) may include a first part (e.g., Part 1 CSI or UCI part 1) and a second part (e.g., Part 2 CSI or UCI part 2). Further, the first part may include information related to determination of a payload size of the second part.

As an example, the frequency domain related information (e.g., the first information selected from all basis sets and the second information selected based on the first information), the spatial domain related information (e.g., the first information selected from all beam sets and the second information selected based on the first information), or the information on the non-zero linear combining coefficient may be included in the second part of the UCI.

For example, an operation of the BS (reference numeral 100 and/or 200 of FIGS. 10 to 14) which receives the UCI for CSI reporting to the UE (reference numeral 100 and/or 200 of FIGS. 10 to 14) in step S930 described above may be implemented by the devices of FIGS. 10 to 14 to be described below. For example, referring to FIG. 11, one or more processors 202 may control one or more transceivers 206 and/or one or more memories 204 so as to receive the UCI for the CSI reporting, and one or more transceivers 206 may receive the UCI for the CSI reporting to the UE.

Through the above-described methods and embodiments, the codebook for Type II CSI reporting may be designed and efficient CSI reporting may be performed in terms of the payload based on a new codebook.

Further, the UE and/or the base station which are operated according to the steps of FIG. 8/FIG. 9, and the above-described methods and embodiments may be specifically implemented by the device of FIGS. 10 to 14. For example, the base station may correspond to a first wireless device, and the UE may correspond to a second wireless device and, in some cases, vice versa.

For example, the above-described base station/UE signaling and operations (e.g., FIG. 8/9) may be processed by one or more processors (e.g., 102 and 202) of FIGS. 10 to 14, and the above-described base station/UE signaling and operations (e.g., FIG. 8/FIG. 9) may be stored in the form of instructions/program (e.g., instructions or executable code) for driving at least one processors (e.g., 102 and 202) of FIGS. 10 to 14, in a memory (e.g., one or more memories (e.g., 104 and 204) of FIGS. 10 to 14).

Communication System Applied to the Disclosure

The various descriptions, functions, procedures, proposals, methods, and/or operational flowcharts of the disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

FIG. 10 illustrates a communication system applied to the disclosure.

Referring to FIG. 10, a communication system (1) applied to the disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. Relay, Integrated Access Backhaul(IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the disclosure.

Devices Applicable to the Disclosure

FIG. 11 illustrates wireless devices applicable to the disclosure.

Referring to FIG. 11, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 10.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the disclosure, the wireless device may represent a communication modem/circuit/chip.

The second wireless device 200 may include at least one processor 202 and at least one memory 204 and additionally further include at least one transceiver 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 206 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. From RF band signals into baseband signals in order to process received user data, control information, radio signals/channels, etc. Using the one or more processors 102 and 202. The one or more transceivers 106 and 206 may convert the user data, control information, radio signals/channels, etc. Processed using the one or more processors 102 and 202 from the base band signals into the RF band signals. To this end, the one or more transceivers 106 and 206 may include (analog) oscillators and/or filters.

Signal Processing Circuit Example to which Disclosure is Applied

FIG. 12 illustrates a signal processing circuit for a transmit signal.

Referring to FIG. 12, a signal processing circuit 1000 may include a scrambler 1010, a modulator 1020, a layer mapper 1030, a precoder 1040, a resource mapper 1050, and a signal generator 1060. Although not limited thereto, an operation/function of FIG. 12 may be performed by the processors 102 and 202 and/or the transceivers 106 and 206 of FIG. 11. Hardware elements of FIG. 12 may be implemented in the processors 102 and 202 and/or the transceivers 106 and 206 of FIG. 11. For example, blocks 1010 to 1060 may be implemented in the processors 102 and 202 of FIG. 11. Further, blocks 1010 to 1050 may be implemented in the processors 102 and 202 of FIG. 11 and the block 1060 of FIG. 11 and the block 1060 may be implemented in the transceivers 106 and 206 of FIG. 11.

A codeword may be transformed into a radio signal via the signal processing circuit 1000 of FIG. 12. Here, the codeword is an encoded bit sequence of an information block. The information block may include transport blocks (e.g., a UL-SCH transport block and a DL-SCH transport block). The radio signal may be transmitted through various physical channels (e.g., PUSCH and PDSCH).

Specifically, the codeword may be transformed into a bit sequence scrambled by the scrambler 1010. A scramble sequence used for scrambling may be generated based on an initialization value and the initialization value may include ID information of a wireless device. The scrambled bit sequence may be modulated into a modulated symbol sequence by the modulator 1020. A modulation scheme may include pi/2-BPSK(pi/2-Binary Phase Shift Keying), m-PSK(m-Phase Shift Keying), m-QAM(m-Quadrature Amplitude Modulation), etc. A complex modulated symbol sequence may be mapped to one or more transport layers by the layer mapper 1030. Modulated symbols of each transport layer may be mapped to a corresponding antenna port(s) by the precoder 1040 (precoding). Output z of the precoder 1040 may be obtained by multiplying output y of the layer mapper 1030 by precoding matrix W of N*M. Here, N represents the number of antenna ports and M represents the number of transport layers. Here, the precoder 1040 may perform precoding after performing transform precoding (e.g., DFT transform) for complex modulated symbols. Further, the precoder 1040 may perform the precoding without performing the transform precoding.

The resource mapper 1050 may map the modulated symbols of each antenna port to a time-frequency resource. The time-frequency resource may include a plurality of symbols (e.g., CP-OFDMA symbol and DFT-s-OFDMA symbol) in a time domain and include a plurality of subcarriers in a frequency domain. The signal generator 1060 may generate the radio signal from the mapped modulated symbols and the generated radio signal may be transmitted to another device through each antenna. To this end, the signal generator 1060 may include an Inverse Fast Fourier Transform (IFFT) module, a Cyclic Prefix (CP) inserter, a Digital-to-Analog Converter (DAC), a frequency uplink converter, and the like.

A signal processing process for a receive signal in the wireless device may be configured in the reverse of the signal processing process (1010 to 1060) of FIG. 12. For example, the wireless device (e.g., 100 or 200 of FIG. 11) may receive the radio signal from the outside through the antenna port/transceiver. The received radio signal may be transformed into a baseband signal through a signal reconstructer. To this end, the signal reconstructer may include a frequency downlink converter, an analog-to-digital converter (ADC), a CP remover, and a Fast Fourier Transform (FFT) module. Thereafter, the baseband signal may be reconstructed into the codeword through a resource de-mapper process, a postcoding process, a demodulation process, and a de-scrambling process. The codeword may be reconstructed into an original information block via decoding. Accordingly, a signal processing circuit (not illustrated) for the receive signal may include a signal reconstructer, a resource demapper, a postcoder, a demodulator, a descrambler, and a decoder.

Example of a Wireless Device Applied to the Disclosure

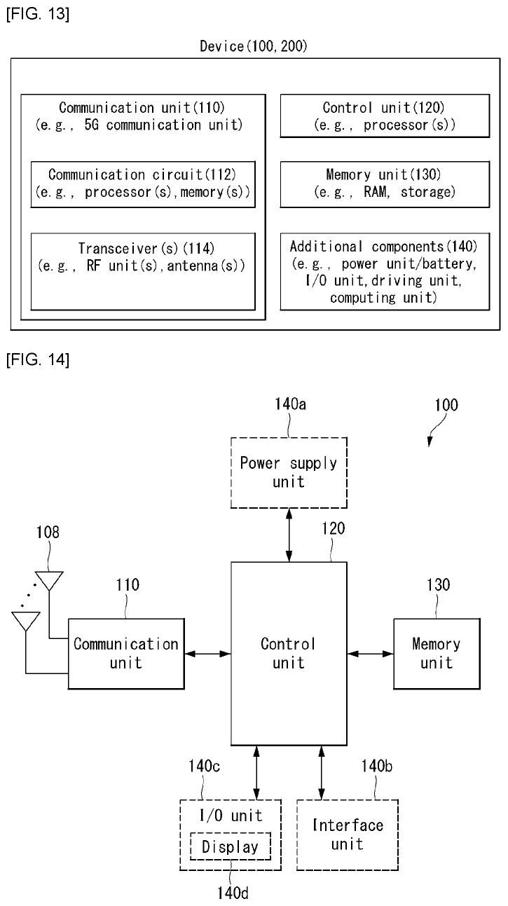

FIG. 13 illustrates another example of a wireless device applied to the disclosure. The wireless device may be implemented in various forms according to a use-case/service (refer to FIG. 10).

Referring to FIG. 13, wireless devices 100 and 200 may correspond to the wireless devices 100 and 200 of FIG. 11 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 104 of FIG. 11. For example, the transceiver(s) 114 may include the one or more transceivers 106 and 106 and/or the one or more antennas 108 and 108 of FIG. 11. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110).

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 10), the vehicles (100b-1 and 100b-2 of FIG. 10), the XR device (100c of FIG. 10), the hand-held device (100d of FIG. 10), the home appliance (100e of FIG. 10), the IoT device (100f of FIG. 10), a digital broadcast terminal, a hologram device, a public safety device, an MTC device, a medicine device, a fintech device (or a finance device), a security device, a climate/environment device, the AI server/device (400 of FIG. 10), the BSs (200 of FIG. 10), a network node, etc. The wireless device may be used in a mobile or fixed place according to a use-example/service.

In FIG. 13, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Portable Device Example to which Disclosure is Applied

FIG. 14 illustrates a portable device applied to the disclosure. The portable device may include a smart phone, a smart pad, a wearable device (e.g., a smart watch, a smart glass), and a portable computer (e.g., a notebook, etc.). The portable device may be referred to as a Mobile Station (MS), a user terminal (UT), a Mobile Subscriber Station (MSS), a Subscriber Station (SS), an Advanced Mobile Station (AMS), or a Wireless terminal (WT).

Referring to FIG. 14, a portable device 100 may include an antenna unit 108, a communication unit 110, a control unit 120, a memory unit 130, a power supply unit 140a, an interface unit 140b, and an input/output unit 140c. The antenna unit 108 may be configured as a part of the communication unit 110. The blocks 110 to 130/140a to 140c correspond to the blocks 110 to 130/140 of FIG. 13, respectively.

The communication unit 110 may transmit/receive a signal (e.g., data, a control signal, etc.) to/from another wireless device and eNBs. The control unit 120 may perform various operations by controlling components of the portable device 100. The control unit 120 may include an Application Processor (AP). The memory unit 130 may store data/parameters/programs/codes/instructions required for driving the portable device 100. Further, the memory unit 130 may store input/output data/information, etc. The power supply unit 140a may supply power to the portable device 100 and include a wired/wireless charging circuit, a battery, and the like. The interface unit 140b may support a connection between the portable device 100 and another external device. The interface unit 140b may include various ports (e.g., an audio input/output port, a video input/output port) for the connection with the external device. The input/output unit 140c may receive or output a video information/signal, an audio information/signal, data, and/or information input from a user. The input/output unit 140c may include a camera, a microphone, a user input unit, a display unit 140d, a speaker, and/or a haptic module.

As one example, in the case of data communication, the input/output unit 140c may acquire information/signal (e.g., touch, text, voice, image, and video) input from the user and the acquired information/signal may be stored in the memory unit 130. The communication unit 110 may transform the information/signal stored in the memory into the radio signal and directly transmit the radio signal to another wireless device or transmit the radio signal to the eNB. Further, the communication unit 110 may receive the radio signal from another wireless device or eNB and then reconstruct the received radio signal into original information/signal. The reconstructed information/signal may be stored in the memory unit 130 and then output in various forms (e.g., text, voice, image, video, haptic) through the input/output unit 140c.

The embodiments described above are implemented by combinations of components and features of the disclosure in predetermined forms. Each component or feature should be considered selectively unless specified separately. Each component or feature may be carried out without being combined with another component or feature. Moreover, some components and/or features are combined with each other and may implement embodiments of the disclosure. The order of operations described in embodiments of the disclosure may be changed. Some components or features of one embodiment may be included in another embodiment, or may be replaced by corresponding components or features of another embodiment. It is apparent that some claims referring to specific claims may be combined with another claims referring to the claims other than the specific claims to constitute the embodiment or add new claims by means of amendment after the application is filed.

Embodiments of the disclosure may be implemented by various means, for example, hardware, firmware, software, or combinations thereof. When embodiments are implemented by hardware, one embodiment of the disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and the like.

When embodiments are implemented by firmware or software, one embodiment of the disclosure may be implemented by modules, procedures, functions, etc. Performing functions or operations described above. Software code may be stored in a memory and may be driven by a processor. The memory is provided inside or outside the processor and may exchange data with the processor by various well-known means.

It is apparent to those skilled in the art that the disclosure may be embodied in other specific forms without departing from essential features of the disclosure. Accordingly, the aforementioned detailed description should not be construed as limiting in all aspects and should be considered as illustrative. The scope of the disclosure should be determined by rational construing of the appended claims, and all modifications within an equivalent scope of the disclosure are included in the scope of the disclosure.

### INDUSTRIAL AVAILABILITY

Although a method for reporting channel state information in a wireless communication system of the present disclosure has been described with reference to an example applied to a 3GPP LTE/LTE-A system or a 5G system (New RAT system), the method may be applied to various wireless communication systems in addition to the 3GPP LTE/LTE-A system or 5G system.

1. A method of reporting, by a user equipment (UE), channel state information (CSI) in wireless communication system, the method comprising:
receiving, from a base station (BS), CSI related configuration information;
receiving, from the BS, a reference signal;
calculating CSI based on the reference signal; and
transmitting, to the BS, Uplink Control Information (UCI) for reporting the CSI,
wherein the CSI is calculated based on a codebook, and
wherein the CSI includes first information and second information selected based on the first information.

2. The method of claim 1,
wherein the first information is information related with a basis of frequency domain.

3. The method of claim 2,
wherein the second information is selected using combinations.

4. The method of claim 1,
wherein the UCI includes a first part and a second part, and
wherein the first information and the second information are included in the second part.

5. The method of claim 4,
wherein only a part of the second information is included in the UCI.

6. The method of claim 1,
wherein a bit width of the UCI is determined based on the first information and the second information.

7. The method of claim 1,
wherein the codebook is determined based on information related to a codebook configuration parameter.

8. The method of claim 7,
wherein the information related to the codebook configuration parameter includes at least one of first parameter information related to a number of bases of spatial domain, second parameter information related to a number of bases of frequency domain, or third parameter information related to a linear combination coefficient.

9. The method of claim 8,
wherein the first parameter information is commonly configured to a rank indicator (RI).

10. The method of claim 8,
wherein the second parameter information is configured based on one of a rank indicator (RI) or a layer.

11. The method of claim 8,
wherein the CSI related configuration information includes information related to the codebook.

12. The method of claim 7,
wherein the codebook is configured based on at least one of a rank indicator (RI) or a layer.

13. A user equipment (UE) configured to report channel state information (CSI) in wireless communication system, the UE comprising:
at least one transceiver;
at least one processor; and
at least one computer memory operably connectable to the at least one processor and storing instructions that, based on being executed by the at least one processor, perform operations comprising:
receiving, from a base station (BS), CSI related configuration information;
receiving, from the BS, a reference signal;
calculating CSI based on the reference signal; and
transmitting, to the BS, Uplink Control Information (UCI) for reporting the CSI,
wherein the CSI is calculated based on a codebook, and
wherein the CSI includes first information and second information selected based on the first information.

14. The UE of claim 13,
wherein the first information is information related with a basis of frequency domain.

15. (canceled)

16. A base station (BS) configured to receive channel state information (CSI) in wireless communication system, the BS comprising:
at least one transceiver;
at least one processor; and
at least one memory operably connectable to the at least one processor and storing instructions that, when executed by the at least one processor, perform operations comprising:
transmitting, to a user equipment (UE), CSI related configuration information;
transmitting, to the UE, a reference signal; and
receiving, from the UE, Uplink Control Information (UCI) for reporting the CSI,
wherein the CSI is calculated based on a codebook, and
wherein the CSI includes first information and second information selected based on the first information.

17-18. (canceled)
